(19) United States
(12) Patent Application Publication
(10) Pub. No.: US 2010/0118200 A1
(43) Pub. Date: May 13, 2010

(54) Signage

(76) Inventors: Geoffrey Michael Gelman, Brooklyn, NY (US); Alexander Epshtegn, Peekskill, NY (US)

Correspondence Address: Geoffrey Gelman, 14 Berkeley Pl, Brooklyn, NY, 11217, US

(21) Appl. No.: 12/615,465

(22) Filed: Nov. 10, 2009

Related U.S. Application Data
(60) Provisional application No. 61/112,838, filed on Nov. 10, 2008.

(51) Int. Cl. H04N 9/74; H04N 5/66; G06F 3/041; G06F 3/045

(52) U.S. Cl. 348/578; 348/739; 345/173; 345/174; 348/E09.055; 348/E05.133

(57) ABSTRACT

According to some embodiments, a digital signage system plays content. According to some embodiments, content may vary based on various circumstances.

### RELATED APPLICATIONS

The present application claims the benefit of priority of U.S. Provisional Patent Application No. 61/112,838, filed Nov. 10, 2008, entitled “SIGNAGE”, the entirety of which is incorporated by reference herein for all purposes.

### BACKGROUND

Advertising and communications have served useful purposes on at least some occasions. Digital signage systems have been used for advertising and communications on at least some occasions.

### BRIEF DESCRIPTION OF THE DRAWINGS

FIG. 1 shows a system according to some embodiments.

FIG. 2 shows a server according to some embodiments.

FIG. 3 shows a media player according to some embodiments.

FIG. 4 shows a computer according to some embodiments.

FIG. 5 shows a display according to some embodiments.

FIG. 6 shows a content database according to some embodiments.

FIG. 7 shows a display database according to some embodiments.

FIG. 8 shows a media player database according to some embodiments.

FIG. 9 shows an entry in a scheduling database according to some embodiments.

FIG. 10 shows a reconciliation database according to some embodiments.

FIG. 11 shows a portion of a user interface for content management according to some embodiments.

FIG. 12 shows a playlist database according to some embodiments.

FIG. 13 shows a portion of a user interface for content management according to some embodiments.

FIG. 14 shows a layout database according to some embodiments.

FIG. 15 shows a display according to some embodiments.

FIG. 16 shows a reconciliation report according to some embodiments.

FIG. 17 shows a process for handling content according to some embodiments.

FIG. 18 shows sensor network according to some embodiments.

FIG. 19 shows rules database according to some embodiments.

FIG. 20 shows a display according to some embodiments.

### DETAILED DESCRIPTION

The following sections I-IX provide a guide to interpreting the present application.

### I. Terms

The term “product” means any machine, manufacture and/or composition of matter, unless expressly specified otherwise.

The term “process” means any process, algorithm, method or the like, unless expressly specified otherwise.

Each process (whether called a method, algorithm or otherwise) inherently includes one or more steps, and therefore all references to a “step” or “steps” of a process have an inherent antecedent basis in the mere recitation of the term ‘process’ or a like term. Accordingly, any reference in a claim to a ‘step’ or ‘steps’ of a process has sufficient antecedent basis.

The term “invention” and the like mean “the one or more inventions disclosed in this application”, unless expressly specified otherwise.

The terms “an embodiment”, “embodiment”, “embodiments”, “the embodiment”, “the embodiments”, “one or more embodiments”, “some embodiments”, “certain embodiments”, “one embodiment”, “another embodiment” and the like mean “one or more (but not all) embodiments of the disclosed invention(s)”, unless expressly specified otherwise.

The term “variation” of an invention means an embodiment of the invention, unless expressly specified otherwise.

A reference to “another embodiment” in describing an embodiment does not imply that the referenced embodiment is mutually exclusive with another embodiment (e.g., an embodiment described before the referenced embodiment), unless expressly specified otherwise.

The terms “including”, “comprising” and variations thereof mean “including but not limited to”, unless expressly specified otherwise.

The terms “a”, “an” and “the” mean “one or more”, unless expressly specified otherwise.

The term “plurality” means “two or more”, unless expressly specified otherwise.

The term “herein” means “in the present application, including anything which may be incorporated by reference”, unless expressly specified otherwise.

The phrase “at least one of”, when such phrase modifies a plurality of things (such as an enumerated list of things), means any combination of one or more of those things, unless expressly specified otherwise. For example, the phrase “at least one of a widget, a car and a wheel” means either (i) a widget, (ii) a car, (iii) a wheel, (iv) a widget and a car, (v) a widget and a wheel, (vi) a car and a wheel, or (vii) a widget, a car and a wheel. The phrase “at least one of”, when such phrase modifies a plurality of things, does not mean “one of each of” the plurality of things.

Numerical terms such as “one”, “two”, etc. when used as cardinal numbers to indicate quantity of something (e.g., one widget, two widgets), mean the quantity indicated by that numerical term, but do not mean at least the quantity indicated by that numerical term.

For example, the phrase “one widget” does not mean “at least one widget”, and therefore the phrase “one widget” does not cover, e.g., two widgets.

The phrase “based on” does not mean “based only on”, unless expressly specified otherwise. In other words, the phrase “based on” describes both “based only on” and “based at least on”. The phrase “based at least on” is equivalent to the phrase “based at least in part on”.

The term “represent” and like terms are not exclusive, unless expressly specified otherwise. For example, the term “represents” do not mean “represents only”, unless expressly specified otherwise. In other words, the phrase “the data represents a credit card number” describes both “the data represents only a credit card number” and “the data represents a credit card number and the data also represents something else”.

The term “whereby” is used herein only to precede a clause or other set of words that express only the intended result, objective or consequence of something that is previously and explicitly recited. Thus, when the term “whereby” is used in a claim, the clause or other words that the term “whereby” modifies do not establish specific further limitations of the claim or otherwise restricts the meaning or scope of the claim.

The term “e.g.” and like terms mean “for example”, and thus does not limit the term or phrase it explains. For example, in the sentence “the computer sends data (e.g., instructions, a data structure) over the Internet”, the term “e.g.” explains that “instructions” are an example of “data” that the computer may send over the Internet, and also explains that “a data structure” is an example of “data” that the computer may send over the Internet. However, both “instructions” and “a data structure” are merely examples of “data”, and other things besides “instructions” and “a data structure” can be “data”.

The term “i.e.” and like terms mean “that is”, and thus limits the term or phrase it explains. For example, in the sentence “the computer sends data (i.e., instructions) over the Internet”, the term “i.e.” explains that “instructions” are the “data” that the computer sends over the Internet.

Any given numerical range shall include whole and fractions of numbers within the range. For example, the range “1 to 10” shall be interpreted to specifically include whole numbers between 1 and 10 (e.g., 1, 2, 3, 4, . . . 9) and non-whole numbers (e.g., 1.1, 1.2, . . . 1.9).

### II. Determining

The term “determining” and grammatical variants thereof (e.g., to determine a price, determining a value, determine an object which meets a certain criterion) is used in an extremely broad sense. The term “determining” encompasses a wide variety of actions and therefore “determining” can include calculating, computing, processing, deriving, investigating, looking up (e.g., looking up in a table, a database or another data structure), ascertaining and the like. Also, “determining” can include receiving (e.g., receiving information), accessing (e.g., accessing data in a memory) and the like. Also, “determining” can include resolving, selecting, choosing, establishing, and the like.

The term “determining” does not imply certainty or absolute precision, and therefore “determining” can include estimating, extrapolating, predicting, guessing and the like.

The term “determining” does not imply that mathematical processing must be performed, and does not imply that numerical methods must be used, and does not imply that an algorithm or process is used.

The term “determining” does not imply that any particular device must be used. For example, a computer need not necessarily perform the determining.

### III. Indication

The term “indication” is used in an extremely broad sense. The term “indication” may, among other things, encompass a sign, symptom, or token of something else.

The term “indication” may be used to refer to any indicia and/or other information indicative of or associated with a subject, item, entity, and/or other object and/or idea.

As used herein, the phrases “information indicative of and “indicia” may be used to refer to any information that represents, describes, and/or is otherwise associated with a related entity, subject, or object.

Indicia of information may include, for example, a code, a reference, a link, a signal, an identifier, and/or any combination thereof and/or any other informative representation associated with the information.

In some embodiments, indicia of information (or indicative of the information) may be or include the information itself and/or any portion or component of the information. In some embodiments, an indication may include a request, a solicitation, a broadcast, and/or any other form of information gathering and/or dissemination.

### IV. Forms of Sentences

Where a limitation of a first claim would cover one of a feature as well as more than one of a feature (e.g., a limitation such as “at least one widget” covers one widget as well as more than one widget), and where in a second claim that depends on the first claim, the second claim uses a definite article “the” to refer to the limitation (e.g., “the widget”), this does not imply that the first claim covers only one of the feature, and this does not imply that the second claim covers only one of the feature (e.g., “the widget” can cover both one widget and more than one widget).

When an ordinal number (such as “first”, “second”, “third” and so on) is used as an adjective before a term, that ordinal number is used (unless expressly specified otherwise) merely to indicate a particular feature, such as to distinguish that particular feature from another feature that is described by the same term or by a similar term. For example, a “first widget” may be so named merely to distinguish it from, e.g., a “second widget”. Thus, the mere usage of the ordinal numbers “first” and “second” before the term “widget” does not indicate any other relationship between the two widgets, and likewise does not indicate any other characteristics of either or both widgets. For example, the mere usage of the ordinal numbers “first” and “second” before the term “widget” (1) does not indicate that either widget comes before or after any other in order or location; (2) does not indicate that either widget occurs or acts before or after any other in time; and (3) does not indicate that either widget ranks above or below any other, as in importance or quality. In addition, the mere usage of ordinal numbers does not define a numerical limit to the features identified with the ordinal numbers. For example, the mere usage of the ordinal numbers “first” and “second” before the term “widget” does not indicate that there must be no more than two widgets.

When a single device or article is described herein, more than one device/article (whether or not they cooperate) may alternatively be used in place of the single device/article that is described. Accordingly, the functionality that is described as being possessed by a device may alternatively be possessed by more than one device/article (whether or not they cooperate).

Similarly, where more than one device or article is described herein (whether or not they cooperate), a single device/article may alternatively be used in place of the more than one device or article that is described. For example, a plurality of computer-based devices may be substituted with a single computer-based device. Accordingly, the various functionality that is described as being possessed by more than one device or article may alternatively be possessed by a single device/article.

The functionality and/or the features of a single device that is described may be alternatively embodied by one or more other devices which are described but are not explicitly described as having such functionality/features. Thus, other embodiments need not include the described device itself, but rather can include the one or more other devices which would, in those other embodiments, have such functionality/features.

### V. Disclosed Examples and Terminology are not Limiting

Neither the Title (set forth at the beginning of the first page of the present application) nor the Abstract (set forth at the end of the present application) is to be taken as limiting in any way as the scope of the disclosed invention(s). An Abstract has been included in this application merely because an Abstract of not more than 150 words is required under 37 C.F.R. .sctn. 1.72(b).

The title of the present application and headings of sections provided in the present application are for convenience only, and are not to be taken as limiting the disclosure in any way.

Numerous embodiments are described in the present application, and are presented for illustrative purposes only. The described embodiments are not, and are not intended to be, limiting in any sense. The presently disclosed invention(s) are widely applicable to numerous embodiments, as is readily apparent from the disclosure. One of ordinary skill in the art will recognize that the disclosed invention(s) may be practiced with various modifications and alterations, such as structural, logical, software, and electrical modifications. Although particular features of the disclosed invention(s) may be described with reference to one or more particular embodiments and/or drawings, it should be understood that such features are not limited to usage in the one or more particular embodiments or drawings with reference to which they are described, unless expressly specified otherwise.

The present disclosure is not a literal description of all embodiments of the invention(s). Also, the present disclosure is not a listing of features of the invention(s) which must be present in all embodiments.

Devices that are described as in communication with each other need not be in continuous communication with each other, unless expressly specified otherwise. On the contrary, such devices need only transmit to each other as necessary or desirable, and may actually refrain from exchanging data most of the time. For example, a machine in communication with another machine via the Internet may not transmit data to the other machine for long period of time (e.g., weeks at a time). In addition, devices that are in communication with each other may communicate directly or indirectly through one or more intermediaries.

A description of an embodiment with several components or features does not imply that all or even any of such components/features are required. On the contrary, a variety of optional components are described to illustrate the wide variety of possible embodiments of the present invention(s). Unless otherwise specified explicitly, no component/feature is essential or required.

Although process steps, algorithms or the like may be described in a particular sequential order, such processes may be configured to work in different orders. In other words, any sequence or order of steps that may be explicitly described does not necessarily indicate a requirement that the steps be performed in that order. The steps of processes described herein may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to the invention(s), and does not imply that the illustrated process is preferred.

Although a process may be described as including a plurality of steps, that does not imply that all or any of the steps are preferred, essential or required. Various other embodiments within the scope of the described invention(s) include other processes that omit some or all of the described steps. Unless otherwise specified explicitly, no step is essential or required.

Although a process may be described singly or without reference to other products or methods, in an embodiment the process may interact with other products or methods. For example, such interaction may include linking one business model to another business model. Such interaction may be provided to enhance the flexibility or desirability of the process.

Although a product may be described as including a plurality of components, aspects, qualities, characteristics and/or features, that does not indicate that any or all of the plurality are preferred, essential or required. Various other embodiments within the scope of the described invention(s) include other products that omit some or all of the described plurality.

An enumerated list of items (which may or may not be numbered) does not imply that any or all of the items are mutually exclusive, unless expressly specified otherwise. Likewise, an enumerated list of items (which may or may not be numbered) does not imply that any or all of the items are comprehensive of any category, unless expressly specified otherwise. For example, the enumerated list “a computer, a laptop, a PDA” does not imply that any or all of the three items of that list are mutually exclusive and does not imply that any or all of the three items of that list are comprehensive of any category.

An enumerated list of items (which may or may not be numbered) does not imply that any or all of the items are equivalent to each other or readily substituted for each other.

All embodiments are illustrative, and do not imply that the invention or any embodiments were made or performed, as the case may be.

### VI. Computing

It will be readily apparent to one of ordinary skill in the art that the various processes described herein may be implemented by, e.g., appropriately programmed general purpose computers, special purpose computers and computing devices. Typically a processor (e.g., one or more microprocessors, one or more microcontrollers, one or more digital signal processors) will receive instructions (e.g., from a memory or like device), and execute those instructions, thereby performing one or more processes defined by those instructions.

A “processor” means one or more microprocessors, central processing units (CPUs), computing devices, microcontrollers, digital signal processors, or like devices or any combination thereof.

Thus a description of a process is likewise a description of an apparatus for performing the process. The apparatus that performs the process can include, e.g., a processor and those input devices and output devices that are appropriate to perform the process.

Further, programs that implement such methods (as well as other types of data) may be stored and transmitted using a variety of media (e.g., computer readable media) in a number of manners. In some embodiments, hard-wired circuitry or custom hardware may be used in place of, or in combination with, some or all of the software instructions that can implement the processes of various embodiments. Thus, various combinations of hardware and software may be used instead of software only.

The term “computer-readable medium” refers to any medium, a plurality of the same, or a combination of different media, that participate in providing data (e.g., instructions, data structures) which may be read by a computer, a processor or a like device. Such a medium may take many forms, including but not limited to, non-volatile media, volatile media, and transmission media. Non-volatile media include, for example, optical or magnetic disks and other persistent memory. Volatile media include dynamic random access memory (DRAM), which typically constitutes the main memory. Transmission media include coaxial cables, copper wire and fiber optics, including the wires that comprise a system bus coupled to the processor. Transmission media may include or convey acoustic waves, light waves and electromagnetic emissions, such as those generated during radio frequency (RF) and infrared (IR) data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, a carrier wave as described hereinafter, or any other medium from which a computer can read.

Various forms of computer readable media may be involved in carrying data (e.g. sequences of instructions) to a processor. For example, data may be (i) delivered from RAM to a processor; (ii) carried over a wireless transmission medium; (iii) formatted and/or transmitted according to numerous formats, standards or protocols, such as Ethernet (or IEEE 802.3), SAP, ATP, Bluetooth™, and TCP/IP, TDMA, CDMA, and 3G; and/or (iv) encrypted to ensure privacy or prevent fraud in any of a variety of ways well known in the art.

Thus a description of a process is likewise a description of a computer-readable medium storing a program for performing the process. The computer-readable medium can store (in any appropriate format) those program elements which are appropriate to perform the method.

Just as the description of various steps in a process does not indicate that all the described steps are required, embodiments of an apparatus include a computer/computing device operable to perform some (but not necessarily all) of the described process.

Likewise, just as the description of various steps in a process does not indicate that all the described steps are required, embodiments of a computer-readable medium storing a program or data structure include a computer-readable medium storing a program that, when executed, can cause a processor to perform some (but not necessarily all) of the described process.

Where databases are described, it will be understood by one of ordinary skill in the art that (i) alternative database structures to those described may be readily employed, and (ii) other memory structures besides databases may be readily employed. Any illustrations or descriptions of any sample databases presented herein are illustrative arrangements for stored representations of information. Any number of other arrangements may be employed besides those suggested by, e.g., tables illustrated in drawings or elsewhere. Similarly, any illustrated entries of the databases represent exemplary information only; one of ordinary skill in the art will understand that the number and content of the entries can be different from those described herein. Further, despite any depiction of the databases as tables, other formats (including relational databases, object-based models and/or distributed databases) could be used to store and manipulate the data types described herein. Likewise, object methods or behaviors of a database can be used to implement various processes, such as the described herein. In addition, the databases may, in a known manner, be stored locally or remotely from a device which accesses data in such a database.

Various embodiments can be configured to work in a network environment including a computer that is in communication (e.g., via a communications network) with one or more devices. The computer may communicate with the devices directly or indirectly, via any wired or wireless medium (e.g. the Internet, LAN, WAN or Ethernet, Token Ring, a telephone line, a cable line, a radio channel, an optical communications line, commercial on-line service providers, bulletin board systems, a satellite communications link, a combination of any of the above). Each of the devices may themselves comprise computers or other computing devices, such as those based on the Intel® Pentium® or Centrino™ processor, that are adapted to communicate with the computer. Any number and type of devices may be in communication with the computer.

In an embodiment, a server computer or centralized authority may not be necessary or desirable. For example, the present invention may, in an embodiment, be practiced on one or more devices without a central authority. In such an embodiment, any functions described herein as performed by the server computer or data described as stored on the server computer may instead be performed by or stored on one or more such devices.

Where a process is described, in an embodiment the process may operate without any user intervention. In another embodiment, the process includes some human intervention (e.g., a step is performed by or with the assistance of a human).

### VII. Continuing Applications

The present disclosure provides, to one of ordinary skill in the art, an enabling description of several embodiments and/or inventions. Some of these embodiments and/or inventions may not be claimed in the present application, but may nevertheless be claimed in one or more continuing applications that claim the benefit of priority of the present application. Applicants intend to file additional applications to pursue patents for subject matter that has been disclosed and enabled but not claimed in the present application.

### VIII. 35 U.S.C. .Sctn. 112

### Paragraph 6

In a claim, a limitation of the claim which includes the phrase “means for” or the phrase “step for” means that 35 U.S.C. .sctn. 112, paragraph 6, applies to that limitation.

In a claim, a limitation of the claim which does not include the phrase “means for” or the phrase “step for” means that 35 U.S.C. .sctn. 112, paragraph 6 does not apply to that limitation, regardless of whether that limitation recites a function without recitation of structure, material or acts for performing that function. For example, in a claim, the mere use of the phrase “step of” or the phrase “steps of” in referring to one or more steps of the claim or of another claim does not mean that 35 U.S.C. .sctn. 112, paragraph 6, applies to that step(s).

With respect to a means or a step for performing a specified function in accordance with 35 U.S.C. .sctn. 112, paragraph 6, the corresponding structure, material or acts described in the specification, and equivalents thereof, may perform additional functions as well as the specified function.

Computers, processors, computing devices and like products are structures that can perform a wide variety of functions. Such products can be operable to perform a specified function by executing one or more programs, such as a program stored in a memory device of that product or in a memory device which that product accesses. Unless expressly specified otherwise, such a program need not be based on any particular algorithm, such as any particular algorithm that might be disclosed in the present application. It is well known to one of ordinary skill in the art that a specified function may be implemented via different algorithms, and any of a number of different algorithms would be a mere design choice for carrying out the specified function.

Therefore, with respect to a means or a step for performing a specified function in accordance with 35 U.S.C. .sctn. 112, paragraph 6, structure corresponding to a specified function includes any product programmed to perform the specified function. Such structure includes programmed products which perform the function, regardless of whether such product is programmed with (i) a disclosed algorithm for performing the function, (ii) an algorithm that is similar to a disclosed algorithm, or (iii) a different algorithm for performing the function.

### IX. Prosecution History

In interpreting the present application (which includes the claims), one of ordinary skill in the art shall refer to the prosecution history of the present application, but not to the prosecution history of any other patent or patent application, regardless of whether there are other patent applications that are considered related to the present application.

### X. Embodiments

### Terminology

A server may include a computer, device, and/or a software application for performing services for connected clients in a client-server architecture. In various embodiments, a server may be dedicated or designated for running specific applications. For example, a server may be dedicated to performing functions related to the Web (a Web server), functions related to electronic mail (e-mail server), or functions related to files (a file server). Exemplary servers include the IBM BladeCenter QS22 blade server, the Sun Fire x64 server, the SPARC Enterprise server, the HP ProLiant DL Server, the Dell PowerEdge 2650 2U Rack Mountable Server, Microsoft's Windows Server 2003, and Microsoft's Exchange Server.

As used herein, the terms “media player”, “digital media player”, and the like may include a device and/or software that converts a first set of data into a second set of data suitable for use by a display. A media player may receive various data streams, including video, audio, text, still images, animations, interactive content, and three-dimensional content. The data streams may be in various formats, including JPEG (Joint Photographic Experts Group), GIF (Graphics Interchange Format), AVI (Audio Video Interleave), RAM (Real Audio Meta-Files), MPEG (Motion Picture Experts Group), QuickTime, MP3 (MPEG Audio Layer III), WMA (Windows Media Audio), AIFF (Audio Interchange File Format), AU (Sun Audio), WAV (Waveform Sound Format), RA (Real Audio), and so on. The media player may convert any one or more of these data streams into one or more signals for use by a display. For example, the media player may convert the data streams into a video and audio signal. A media player may incorporate data from multiple streams into a single video signal. For example, a media player may receive video data depicting a gazelle running on a savannah, as well as data about current stock prices. The media player may create a single video signal which incorporates both the video of the gazelle running and a scrolling ticker showing the stock prices.

A media player may perform decompression, decoding, decrypting or other functions on data. For example, a media player may include a codec for Quicktime, which may allow it to decompress received video that is in Quicktime format. A media player may alter the pixel layout of incoming data. For example, the media player may receive a video signal representing X by Y pixels, and convert the video signal into a video signal representing W by Z pixels.

A media player may change the frame rate of a signal. For example, a media player may convert a 30 frame-per-second signal into a 24 frame-per-second signal. A media player may change the sample rate of a signal. For example, a media player may receive an audio signal sampled at 96,000 Hertz, and convert it to an audio signal sampled at 32,000 Hertz.

A media player may include logic indicative of which content should be played on a corresponding display. The media player may further include logic indicative of when content should be played on the corresponding display. Thus, a media player may receive a number of data stream and only cause a subset of such data stream to be featured on a corresponding display.

A media player may further include logic indicative of the manner in which content should be played on a corresponding display. Such logic may indicate where on a screen that content should be placed (e.g., upper right-hand corner), the shape of the region where the content is to be placed, what types of visual effects to add to the content (e.g., borders; e.g., fade-ins and fade-outs), and any other information about the manner in which the content is to be played.

Exemplary media players include the Digital Signage Player NDSP-500 from ICP Advanced Digital Signage, the Cisco Digital Media Player 4305G, the NEOCAST Media Player appliance, View Sonic's NMP530, the 1-2-1VIEW Ninja N106, and Scala's InfoChannel Player.

A media player may include a computer running software. The computer may be a general purpose computer, such as a personal computer. The computer may have a specially designed shape or form factor. A special form factor may allow the computer to be situated into small, oddly shaped, and/or inaccessible locations, for example.

A media player may include a dedicated computer, such as a set-top box. The media player may include specially optimized hardware for performing the functions of a media player.

A media player may be integrated into a display, speaker, or other output device. For example, a display may include a motherboard, a processor, and memory, wherein the processor may execute a program to perform one or more functions of a media player.

A media player may be operable to recognize and process data in various formats such as Quicktime, Flash, and Windows Media.

A media player may include software, hardware, and/or a combination of hardware and software.

As used herein, the term “content manager” may include hardware and/or software for scheduling the delivery and playback of content at one or more output devices (e.g., at one or more displays). A content manager may monitor when and where content has been played, and may provide reports on when and where content has been played. A content manager may provide functionality for allowing different people to provide and schedule content. For example, in a large network of digital signs, a first person (e.g., a corporate manager) may have the authority to schedule content on all of the digital signs, while a second person (e.g., a local store manager) may have the authority to schedule content on a subset of signs within the network. An example of a content manager is Scala's InfoChannel Content Manager.

As used herein, the term “OpenGL”, or “Open Graphics Library” may include a standard specification that defines a cross-language and cross-platform applications programming interface for creating applications that generate two and three dimensional computer graphics.

In various embodiments, communication among devices on a network may be accomplished via various communications mediums, including via category 5 cable (CAT5 cable), fiber optic cable, and Ethernet. Communications may be accomplished using various other mediums, as will be appreciated, including wired and wireless mediums.

A networked-attached storage (NAS) device may include a self-contained computer connected to a network, and may serve the purpose of supplying file-based data storage services to other devices on the network. An operating system and other software on the NAS device may provide such functionality as data storage, file systems, and access to files, and the management of these functionalities. An NAS device may lack a keyboard or display, and may be controlled and configured over the network, such as through the connection of a browser program to its network address.

In some embodiments, other devices may assume or carry out the function of an NAS. In some embodiments, a computer may be used as a file server. A file server may include a computer with a keyboard, display, and operating system, in which the operating system may be optimized for providing storage services.

Exemplary NAS devices include the Netgear ReadyNAS Duo, the Netgear ReadyNAS NV+, the Iomega StorCenter Network Hard Drive, the Synology Disk Station DS207+, and the Maxtor Shared Storage II.

A storage area network (SAN) may include a network that connects data storage devices (e.g., disk arrays, tape libraries, optical jukeboxes) to one or more data servers. The architecture of the SAN may be such that, from the viewpoint of the operating systems of the server(s), the storage devices appear as locally attached. The SAN may be dedicated to only input-output traffic between servers and storage devices. An SAN may incorporate various communication technologies, including for example, optical fiber, Enterprise Systems Connection (ESCON), or Fibre Channel.

A blade server may include a hardware server that is specially designed to be densely packed with other blade servers. Multiple blade servers may be arranged together within a chassis, and may share components such as power supplies and cooling systems. In this way, a large number of servers may be packed into a small volume.

A Universal Serial Bus (USB) drive may include a memory storage device integrated with a universal serial bus (USB) connector. The memory used by the USB drive may be flash memory.

Radio-frequency identification (RFID) may include a method of identifying objects via data emitted by and/or received from special tags or transponders. Such tags may be called RFID tags. RFID tags may be small devices capable of emitting or retransmitting electro-magnetic radiation where such radiation encodes data. RFID tags may be incorporated into products, animals, or people and imbued with unique or distinctive data that allows the identification of such products, animals or people.

Display technologies may include cathode-ray tubes (CRT), liquid crystal displays (LCDs), thin film transistor (TFT) LCDs, plasma screen displays, light-emitting diode (LED) displays, organic light-emitting diode (OLED) displays, projection displays, digital light processing (DLP) projectors, holographic displays, displays made from spinning arrays of LEDs (e.g., displays by DynaScan 360), electronic paper or electronic ink (E-ink) displays, laser projection systems, and so on.

A graphics processing unit (GPU) may include a device that is specially dedicated to rendering graphics for a personal computer, game console, workstation, or for another other device. Exemplary GPUs include the NVIDIA GeForce 8800 Ultra, the NVIDIA GeForce 8800 GTX, the ATI Radeon HD 3870 X2, and the ATI Radeon HD 3870.

As used herein, the terms “central processing unit”, “CPU”, and “processor” may include a device that executes computer programs. The CPU may include a semiconductor device incorporating transistors and logic elements, for example. Exemplary processors may include the Intel Core 2 Extreme Processor, Intel Pentium Processor, Intel Celeron Processor, Intel Xeon Processor, AMD Phenom Processor, AMD Athlon Processor, AMD Turion Processor, and AMD Opteron. A processor may include a processor with a reduced instruction set computer (RISC) architecture. A processor may include a processor with an Advanced RISC Machine (ARM) architecture.

As used herein the terms “RSS”, “Really Simple Syndication”, “Rich Site Summary”, “RDF Site Summary”, and the like may include one or more Web feed formats used to publish frequently updated works, e.g., blog entries, news headlines, stock quotes, audio, and video. An RSS document may include full or summarized text and meta-data such as the authors and dates of publishing.

### Digital Signage System

According to various embodiments, a digital signage system may allow for visual, audio, or other content to be broadcast through one or more displays or other output devices. The displays or other output devices may be digital signs, digital billboards, projection displays, speakers, printers, product vending machines, hand dryers, kiosks, or any other output device. A digital signage system may include one or more output devices connected to a network. In various embodiments, a digital signage system may be centrally controlled and managed. For example, a server may store content that is to be played on the displays and other output devices within a network. The server may periodically transmit or broadcast the content to the output devices within the network. The server may also store scheduling information as to when and where content is to be played. The server may further perform monitoring and reconciliation functions. The server may monitor when parts of the network are not functioning properly. The server may track what content has been played, when it has been played, how effective it has been, and any other metrics.

In various embodiments, a digital signage system may be managed via distributed locations, devices, and or human managers. For example, a digital signage system spread amongst a retail chain may allow a manager in corporate headquarters to determine content that will be played on all displays throughout the system. At the same time, a manager of a single retail store may determine content that will be played on the displays within his retail store.

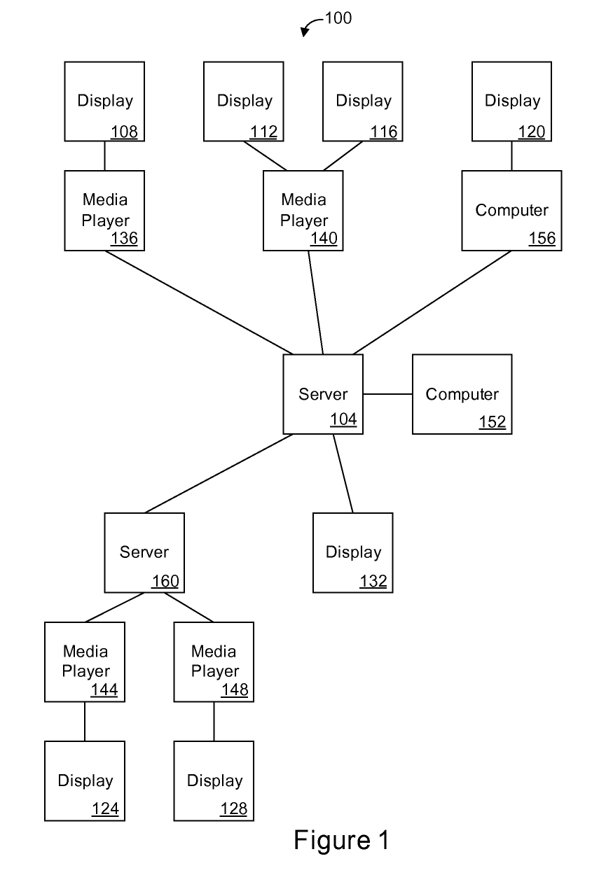

FIG. 1 shows a system 100 according to some embodiments. System 100 is illustrative of one or more possible system architectures, but it should be understood that various embodiments may include alternate architectures. Server 104 may be linked with various other devices and/or programs. In various embodiments, server 104 is linked to media players 136 and 140, to computers 152 and 156, to server 160, and to display 132. It will be appreciated that, in various embodiments, server 104 may be linked to any number of devices and/or programs, including various media players, computers, servers, displays, and/or other programs or devices.

As described herein, a link or links may occur via one or more communications channels, including Ethernet, coaxial cable, CAT5 cable, optical fibers, copper wires, wireless links, infrared links, satellite links, or via any other mode of communication. The link or links may occur through one or more networks, including the Internet, telecommunications networks, cable networks, satellite networks, local area networks (LANs), wide area networks (WANs), virtual private networks (VPNs), or via any other networks. Links may be continuous, periodic, intermittent or any other duration or frequency. In some embodiments, a link may include a “sneaker net”, whereby data is shuttled between devices via humans carrying data (e.g., by humans carrying flash memory drives or other computer media).

Media players, such as media players 136, 140, 144, and 148, may each be linked to one or more displays. For instance, in various embodiments, media player 136 is linked to display 108, media player 140 is linked to displays 112 and 116, media player 144 is linked to display 124, and media player 148 is linked to display 128. As will be appreciated, in various embodiments, a given media player may be linked to any number of displays.

System 100 illustrates “displays”. Various embodiments may include output devices that do not strictly output visual information. For example, output devices may include devices which output audio, vibrations, aromas, heat, water, air, paper, products, and/or any other type of output. For example, an output device may include a speaker that outputs music. An output device may include a spray nozzle that outputs cold spray on a hot day. An output device may include a fan that provides air currents on a hot day. An output device may include a printer that provides coupons. An output device may include a vending machine that outputs candies. In various embodiments, an output device may output a combination of stimuli, including visual and audio stimuli, for example. It will be appreciated that various embodiments may utilize architectures illustrated in system 100 with output devices that do not strictly provide visual information. For example, a media player may be linked to a speaker that outputs audio stimuli.

Computer 156 may include a computer that functions as a media player. The computer may also include additional functionality. The computer may allow for direct human interaction. For example, the computer may include a monitor, keyboard, and mouse for interacting with a person. A person may use the computer, for example, to load or manage content to be output on display 120. The computer may run media player software and may thereby function as a media player.

Computer 152 may include a general purpose computer, such as a personal computer, a workstation, or any other type of computer. Computer 152 may provide a human with a way to interact with server 104. For example, a human may provide instructions for the server via computer 152. A human may use computer 152 for a variety of functions, including loading content that will be stored on the server 104 and broadcast to one or more displays; scheduling content to be broadcast to one or more displays; scheduling content to be played on one or more displays; monitoring when content has been played on one or more displays; monitoring displays or other network components that are not functioning; and/or performing any other function. Although the illustrated system 100 includes one computer that may be used for interacting with server 104, various embodiments contemplate the use of zero, one, or more than one computer that may be used for interacting with server 104. For example, three different people may share the responsibility of managing a digital signage system. Each may access server 104 using a different computer.

Server 104 may perform various functions. In various embodiments, server 104 may store content such as video files, still images, financial data, weather data, text data, other data, audio files, and any other content. Server 104 may broadcast such content to one or more other devices and/or programs, including to media players, computers, displays, and to other servers (e.g., to server 160). Server 104 may further receive information from one or more other devices and/or programs. Server 104 may receive information such as what content was played, when content was played, and how many people viewed content that was played. Server 104 may further receive status information regarding the digital signage system. For example, server 104 may receive a signal indicating that a media player has lost a network connection (e.g., and the media player is therefore not able to communication with the server). As another example, server 104 may receive a signal indicating that a display is not showing any images.

In various embodiments, one or more media players and/or displays may be linked to a server other than to server 104. For example, media player 136 may be linked to a server other than server 104. The other server may be external to the digital signage network 100, in some embodiments. The other server may, in some embodiments, provide content for the one or more media players and/or displays. For example, media player 104 may be configured to receive an RSS feed directly from an external server. A media player and/or display may, in various embodiments, receive content, instructions, or any other data directly from a source external to the digital signage system. In some embodiments, while a media player and/or display may receive content from an external source, server 104 may provide the media player and/or display with instructions as to when to play such content.

Server 104 may be linked to server 160. In various embodiments, server 104 may be linked to zero, to one, or to more than one additional server. In various embodiments, server 104 may be linked to any number of other servers. Server 160 may perform one or more similar functions to those performed by server 104. For example, server 160 may store content. Server 160 may transmit or broadcast content to one or more media players, displays, and/or other devices. Server 160 may schedule the playing of content on one or more displays. Server 160 may also monitor the status of a network or portion of a network.

In various embodiments, server 160 may have dedicated or specialized functionality. Server 160 may store content. Server 160 may store large content files, such as video files. Server 160 may be located more proximate to media players 144 and 146 than is server 104, for example. Thus, if content files are stored at server 160, network lags inherent in the transmission of content to media players 144 and 148 may be reduced.

Display 132 may be linked directly to server 104. Display 132 may include an integrated media player. For example, display 132 may include a processor and may operate software with the functionality of a media player.

Though various embodiments illustrate or depict discrete components, it will be appreciated that components may be comprised of one or more separate devices. It will be appreciated that components may be comprised of one or more distributed components. For example, server 104 may comprise multiple discrete servers that are networked together and which function as a single server. It will be further appreciated that components illustrated as discrete may be combined. For example, media player 136 and display 108 may be combined into a single device. As another example, computer 152 and server 104 may be a combined into single device.

### Server

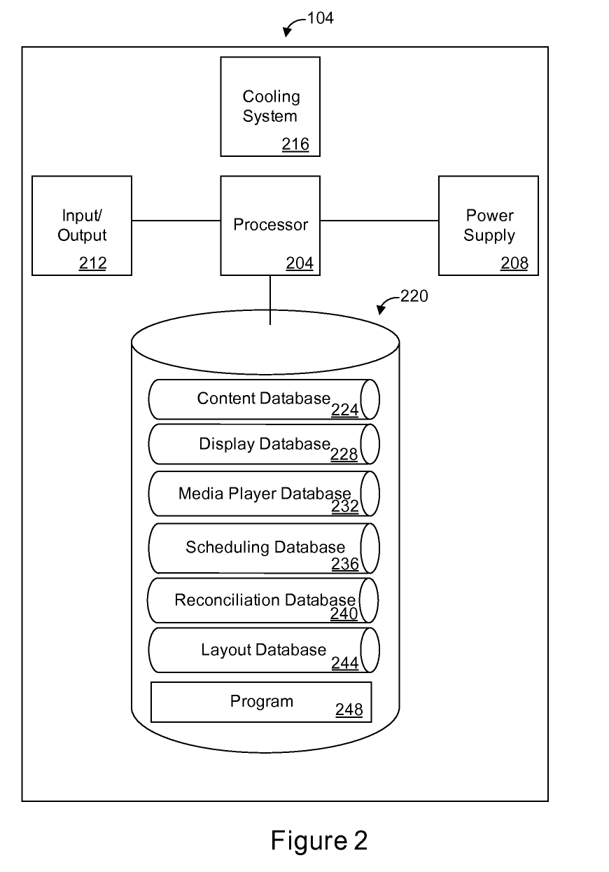

FIG. 2 shows server 104 according to some embodiments. Server 104 may include a processor 204. The processor may execute programs or other sets of instructions so as to operate in accordance with one or more embodiments. Server 104 may, in various embodiments, include multiple processors.

Server 104 may include input and output communication abilities 212. Such capabilities may include ports, communication ports, data ports, antenna(e), wireless transmitters, laser transmitters, infrared transmitters, cables, and any other mechanisms for transmitting or receiving data. Server 104 may include one or more monitors, keyboards, computer mice, or other devices that allow for communication and interaction with a human.

Server 104 may include a power supply 208. The power supply may convert power received from an electrical grid into power suitable for use by other server components. For example, the power supply may convert power from alternating current to direct current and may change the voltage. In various embodiments, the power supply may comprise one or more batteries, one or more generators, one or more fuel cells, one or more engines, or any other suitable source of power.

Server 104 may include a cooling system 216. The cooling system may use air currents, liquid, heat syncs, and/or any other mechanism for cooling one more components of server 104.

Server 104 may include memory 220. Memory 220 may store various data. In various embodiments, the data may be stored within databases, such as databases 224, 228, 232, 236, 240, and 244. However, it should be understood that data may be stored in other manners, formats, arrangements, etc. Memory 220 may store one or more programs, such as program 248. The programs may include instructions for directing processor 204 (or any other processor) in accordance with various embodiments. Memory 220 may store any instructions for directing the processor or any other component of server 104.

Content database 224 may include various data, such as data to be utilized by one or more media players (e.g., by media player 136), and/or to be used by one or more displays (e.g., by displays 108 and 132). Data stored in the content database may include video data, image data, audio data, speech data, text data, data representing symbols, data representing animations, and/or any other type of data. Data stored in the content database 224 may, in various embodiments, be transmitted (e.g., transmitted via input/output mechanisms 212) to one or more media players, displays, servers, or to any other devices. Content database 224 may store “meta-data” pertaining to any content stored. For example, content database 224 may store text labels of images, data indicating the length of a video, data indicating the number of pixels in an image, data indicating the bit rate of an audio file, and any other data related to content. In some embodiments, content database 224 may store a pointer or other reference to content data that is not stored in the content database. For example, the content database may store an internet protocol (IP) address of a remote server where actual content data may be found.

Display database 228 may include data related to one or more displays in digital signage system 100, or in any other system. For example, the display database may include information about the location or hardware specifications of one or more displays.

Media player database 232 may include data related to one or more media players in digital signage system 100, or in any other system. For example, the media player database may include information about which displays are linked to a given media player.

Scheduling database 236 may include data related to the presentation of content within digital signage system 100, or within any other system. Scheduling database may include, for example, information about what content will be played on a given display, and when such content will be played.

Reconciliation database 240 may include data related to when and where content has been played. Reconciliation database 240 may, for example, aid in billing advertisers for the successful presentation of content over digital signage system 100.

Layout database 244 may include data related to different screen layouts. For example, a user of digital signage system 100 may wish to create and/or select from among different layouts. A layout may represent the way a screen is divided into different regions, such that each region can play a separate, independent item of content. In some embodiments, a layout may also include characteristics that are applied to different regions, such as transparency levels or border thicknesses.

It should be understood that the databases depicted in FIG. 2 represent some embodiments. More or fewer databases may also be used, in various embodiments. Further, the depicted databases may store data in various ways, in various arrangements, and in various relationships, according to various embodiments. Further, the depicted databases may store more or less data, according to some embodiments.

It will be appreciated that although FIG. 2 depicts an exemplary architecture for server 104 according to some embodiments, the architecture may also describe one or more other servers in digital signage system 100. Further, server 104 may itself comprise other architectures, in various embodiments.

### Media Player

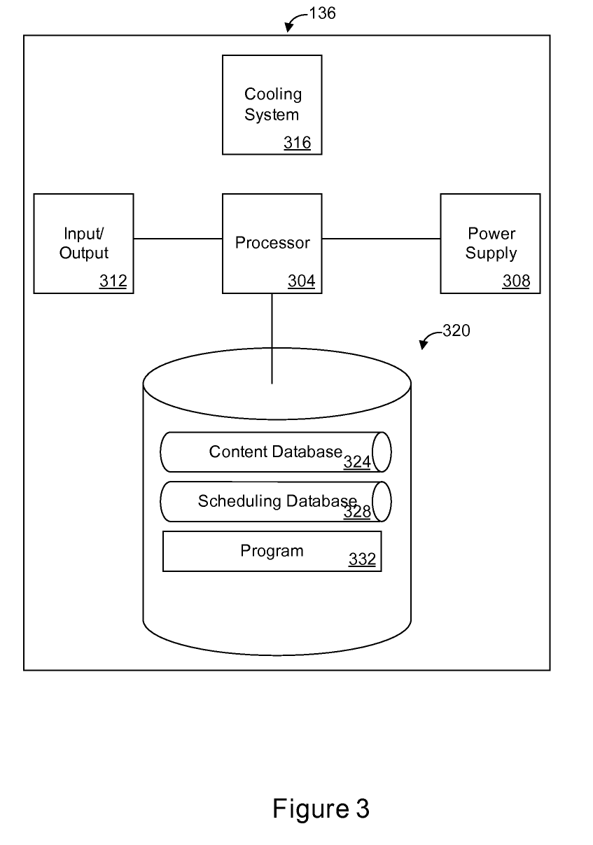

FIG. 3 depicts a media player 136, according to some embodiments. The media player may include a processor 304 for executing programs and carrying out instructions to operate in accordance with various embodiments. The media player may include more than one processor, in various embodiments. For example, the media player may include a GPU as well as a CPU. The media player may include an input and/or output mechanisms 312. The input and/or output mechanisms may include ports for cables, Ethernet, fiber optics, or other modes of transmission and communication. The input and/or output mechanisms may include means for wireless communications, including antenna, infrared transmitters and/or receivers, lasers, and/or any other mechanisms for wireless communications. The input and/or output mechanisms may include a monitor or display screen and/or a microphone, both of which may be used to present information to humans. The media player may include an attached mouse, keyboard, joystick, or other mechanism for human interaction.

The media player 136 may include a power supply 308, such as a battery or power adapter. The media player may include a cooling system 316. The cooling system may help to dissipate heat from the processor, from other electronics, from sunlight, from a nearby display, or from any other source. The media player may include a memory 320, such as a semiconductor memory, hard disk, flash memory, holographic memory, or any other type of memory. Stored in memory may be various information, including, in some embodiments, a content database 324, a scheduling database 328, and a program 332. Content database 324 may, in some embodiments, bear similarities to content database 224 stored in server 104. Scheduling database 328 may, in some embodiments, bear similarities to scheduling database 236 stored in server 104. In some embodiments, only one of server 104 or a media player stores a content database. In some embodiments, only one of server 104 or a media player stores a scheduling database. It will appreciated that various data may be stored in various places, including in redundant places. For example, both the server 104 and a media player may store a schedule for when content is to be played on a display associated with the media player.

Media player 136 may include one or more programs, e.g., program 332. The program may include instructions for operating the media player in accordance with various embodiments.

It will be appreciated that although FIG. 3 depicts an exemplary architecture for media player 136 according to some embodiments, the architecture may also describe one or more other media players in digital signage system 100.

### Personal Computer

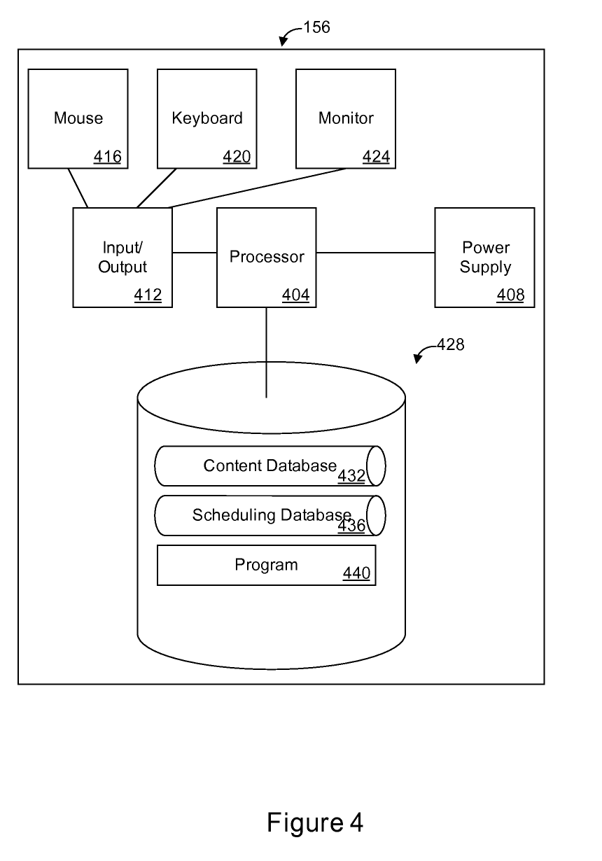

FIG. 4 depicts personal computer 156, according to some embodiments. The personal computer may include a processor 404. The processor may be operable to execute programs or to carry out other instructions in accordance with various embodiments. The personal computer may include more than one processor, in various embodiments. In various embodiments, personal computer may include a power supply 408, such as a battery or a power adapter. In various embodiments, the personal computer may include mechanisms for inputs and outputs 412. For example, the personal computer may include ports for cables, Ethernet, fiber optics, and other communication and transmission means. The personal computer may include mechanisms for wireless input and outputs. The personal computer may feature Bluetooth, Wi-Fi, or other wireless protocols. The personal computer may include one or more antennae for wireless reception and transmission. In various embodiments, the personal computer may include transmitters and/or receivers for infrared signals and/or for lasers. In various embodiments, the personal computer may include a mouse 416, keyboard 420, and monitor 424. These may allow for interaction with a human. The computer may include one or more other features or peripherals for interaction with humans as well. In some embodiments, the personal computer may include a microphone, camera, or other input or output mechanism.

The personal computer may include a memory 428, such as a semiconductor memory, hard disk, flash memory, holographic memory, or any other type of memory. Stored in memory may be various information, including, in some embodiments, a content database 432, a scheduling database 436, and a program 440. Content database 432 may, in some embodiments, bear similarities to content database 224 stored in server 104. Scheduling database 436 may, in some embodiments, bear similarities to scheduling database 236 stored in server 104. In some embodiments, only one of server 104 or a personal computer stores a content database. In some embodiments, only one of server 104 or a personal computer stores a scheduling database. It will appreciated that various data may be stored in various places, including in redundant places. For example, both the server 104 and a personal computer may store a schedule for when content is to be played on a display associated with the personal computer.

Personal computer 156 may include one or more programs, e.g., program 440. The program may include instructions for operating the personal computer in accordance with various embodiments.

In various embodiments, personal computer 156 may execute media player software. For example, personal computer 156 may receive signals from the server 104, where such signals encode content. The computer may decode the signals and transmit the decoded signals to the display for presentation. The computer may also combine different content signals into a single composite (e.g., into a single composite image), and transmit the composite to the display. For example, the computer may transmit a signal to the display for presentation, where the presentation shows two separate video clips simultaneously.

It will be appreciated that although FIG. 4 depicts an exemplary architecture for personal computer 156 according to some embodiments, the architecture may also describe one or more other personal computers in digital signage system 100.

### Display

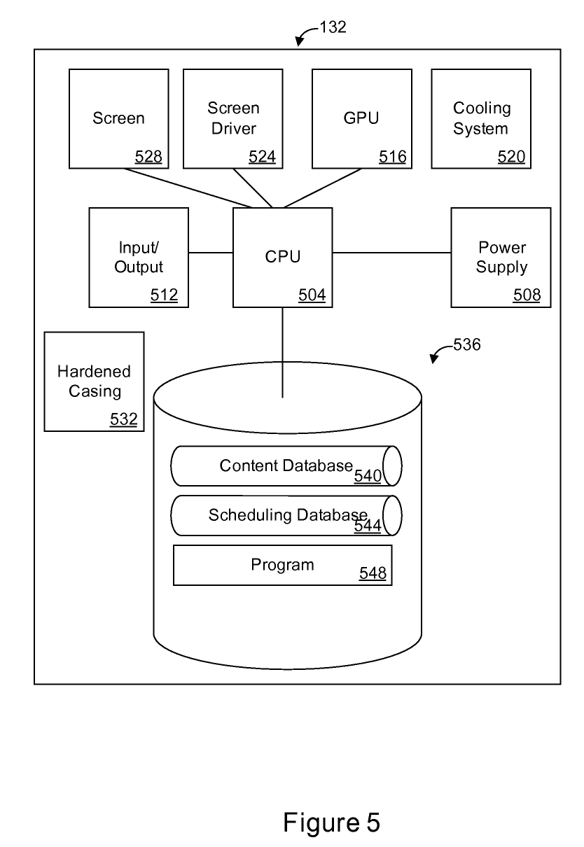

FIG. 5 depicts display 132, according to some embodiments. The display may include a central processing unit (CPU) 504. The CPU may be a processor. The CPU may be a general purpose computer processor. The CPU may be operable to execute programs or to carry out other instructions in accordance with various embodiments. The display may include more than one processor, in various embodiments. In various embodiments, the display may include a power supply 508, such as a battery or a power adapter.

In various embodiments, the display may include mechanisms for inputs and outputs 512. For example, the display may include ports for cables, Ethernet, fiber optics, and other communication and transmission means. The display may include mechanisms for wireless input and outputs. The display may feature Bluetooth, Wi-Fi, or other wireless protocols. The display may include one or more antennae for wireless reception and transmission. In various embodiments, the display may include transmitters and/or receivers for infrared signals and/or for lasers.

In various embodiments, the display 132 may include mechanisms for receiving human inputs. In some embodiments, the display may include touch sensors and/or a touch screen for receiving tactile input. In various embodiments, the display 132 may include a camera for detecting images (e.g., images of humans). In various embodiments, the display may include a microphone or other acoustic sensor.

In various embodiments, the display 132 may include output devices, such as output devices capable of communicating with humans. Output device may include speakers, acoustic transmitters, directional sound transmitters, chemical or odor releasers, nozzles for water or air, or any other output devices.

In various embodiments, the display 132 may include a GPU. The GPU may assume some of the processing work by performing common and frequently used calculations, such as calculations related to graphics.

In various embodiments, the display 132 may include a cooling system 520. The cooling system may include one or more fans, one or more heat syncs, one or more pipes for circulating liquid and/or gas, and/or one or more other components. The cooling system 520 may allow the display 132 to expend large quantities of energy, to operate under warm ambient conditions, to operate in tight spaces, or to otherwise operate without overheating.

In various embodiments, the display 132 may include a screen driver 524. The screen driver may provide a go-between or middleware, that allows e.g., the CPU to issue commands to the screen of the display.

In various embodiments, the display 132 may include a screen. The screen may include glass, filters, liquid crystals, a light source, transistors, phosphorous, light emitting diodes, organic light emitting diodes, and/or other components. The screen may transmit and/or reflect light. The screen may display particular images or patterns, and may do so in response to commands from the CPU, GPU, screen driver, or other source.

In various embodiments, the display 132 may include a hardened casing 532. The hardened casing may include mechanically resistant glass, plastic, metal, or other materials that are used to cover and/or protect the other parts of display 132. In some embodiments, the display may include decorative coverings or casings, such as a gold bezel.

In various embodiments, the display may include a memory 536, such as a semiconductor memory, hard disk, flash memory, holographic memory, or any other type of memory. Stored in memory may be various information, including, in some embodiments, a content database 540, a scheduling database 544, and a program 548. Content database 540 may, in some embodiments, bear similarities to content database 224 stored in server 104. Scheduling database 544 may, in some embodiments, bear similarities to scheduling database 236 stored in server 104. In some embodiments, only one of server 104 or a display stores a content database. It will appreciated that various data may be stored in various places, including in redundant places. For example, both the server 104 and a display (e.g., display 132) may store a schedule for when content is to be played on the display.

Display 132 may include one or more programs, e.g., program 548. The program may include instructions for operating the display in accordance with various embodiments.

In various embodiments, display 132 may execute media player software. For example, display 132 may receive signals from the server 104, where such signals encode content. It will be appreciated that although FIG. 5 depicts an exemplary architecture for a display 132 according to some embodiments, the architecture may also describe one or more other displays in digital signage system 100.

### Databases

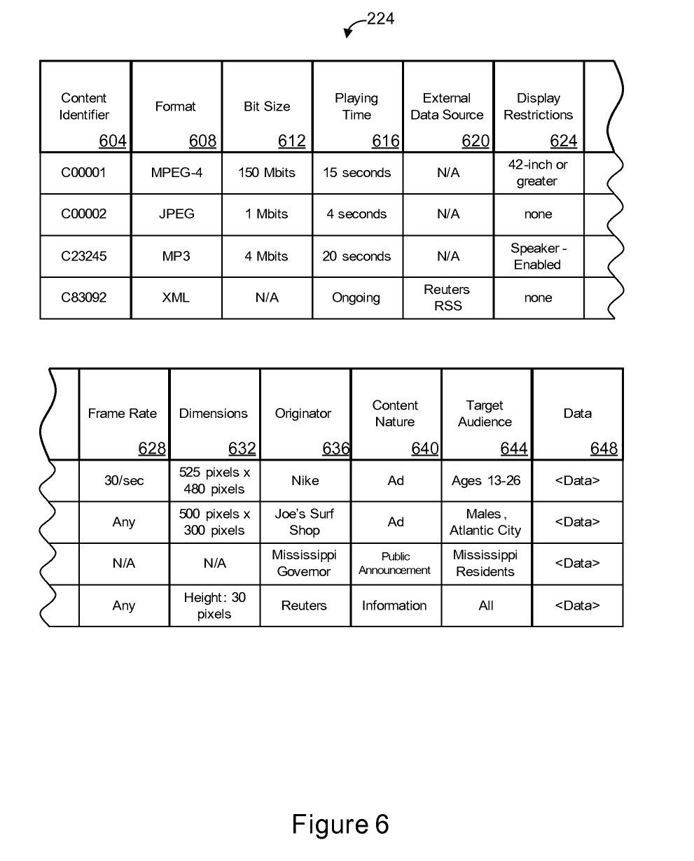

FIG. 6 depicts a representation of content database 224 according to some embodiments. Each row in content database 224 may represent a single item of content, such as a single image or a single 15-second video spot. Field 604 may include identifiers (e.g., C00001, C23245) which may be used to specify or reference particular items of content. Field 608 may include indications of the format of content (e.g., MPEG-4; e.g., JPEG). Field 212 may include indications of the size items of content. The size may be indicated in bits, bytes or in any other suitable unit of measurement. In various embodiments, content may have no definite size. For example, a particular item of content may be an RSS feed that is periodically or continuously updated and which therefore has no definite end. For content without a definite end, size may be measured per unit time (e.g., bits per second), in some embodiments.

Field 616 may include indications of the playing time of content (e.g., 4 seconds). In some embodiments, content may represent a live or continuous feed, or may otherwise have an indefinite length. For such content, an indication of “ongoing” may be used, in some embodiments. The playing time indicated for a particular item of content may represent a permissible or preferred playing time, in some embodiments. For example, a particular item of content may be a single still image. The indicated playing time may represent the amount of time the image is to be shown on a display according to the preferences of the content provider (e.g., according to the preferences of an advertiser). However, in various embodiments, the playing time of content may be changed. For example, a still image may have a preferred playing time of three seconds. However, this playing time may be reduced to two seconds or increased to five seconds. A playing time may be altered, for example, if an operator of digital signage system 100 wishes to fill extra time or to open up extra slots for additional content. In various embodiments, content database 224 may include a field indicating a minimum permissible playing time and/or a field indicating a maximum permissible playing time.

In some embodiments, an item of content may be played in two or more different versions. For example, for a movie trailer, there may be a 30-second version and a 15-second version. The 15-second version may be the first half of the 30-second version. In some embodiments, content database 224 may include one or more fields indicating a point at which an item of content may be truncated or abbreviated in order to yield a shorter version of that content. In some embodiments, two or more possible versions of a content item may be stored as separate content items, e.g., as separate rows in content database 224.

Field 620 may indicate an external data source from which content is to be received, obtained, or otherwise derived. For example, in some embodiments, server 104 does not store all content that is to be played on displays in system 100. Rather, in some embodiments, server 104 may stream content from another source and relay that content on to one or more displays in system 100. In some embodiments, server 104 may never receive certain content. Rather, such content may be transmitted directly from an external source to one or more media players and/or displays in digital signage system 100. In some embodiments, content may be stored within digital signage system 100, but not within server 104. For example, content may be stored in a dedicated content server, in network attached storage (NAS), in a server area network (SAN), or on any other device or in any other location within digital signage system 100.

Field 624 may indicate one or more restrictions that should or must be met by a display in order for content to be played on that display. Such restrictions may represent technical restrictions (e.g., an item of content may be unplayable on certain displays), restrictions of the content provider (e.g., an advertiser may prefer that his ad play only on displays of a certain size), or any other restrictions. In various embodiments, restrictions may also be stored for a media player. For example, certain content may be undecipherable by a certain media player. Restrictions may also be stored for a network connection (e.g., a network connection may be too intermittent for particular content to be streamed live to a particular media player). In various embodiments, any restrictions which may prevent, hinder, or impede the playing of content may be stored. In various embodiments, any restrictions which indicate situations where the playing of content would be unwanted or undesirable may be stored.

Field 628 may indicate a frame rate. The frame rate may represent a preferred or required frame rate at which content should or must be played. For example, certain content may appear smooth at a first frame rate, but may appear jerky at a second frame rate. Thus, it may be preferable to play the content at the first frame rate. In some embodiments, there may be a preferred bit rate or sample rate at which to play audio content. Such a preferred rate may be stored in a database such as content database 224.

Field 632 may indicate dimensions for an item of content. In various embodiments, a given item of content need not be displayed on the entire area of a display. For example, an item of content may be displayed in a quadrant of a display screen, thereby allowing for three other similarly sized items of content to also be displayed at the same time. A given item of content may occupy a square or rectangular portion of a display screen, in some embodiments. In some embodiments, a given item of content may occupy a band stretching the length or the width of a display screen. For example, an item of content may be displayed as a ticker stretching across the width of a displays screen. In some embodiments, an item of content may occupy a region of a display screen that is round, hexagonal, or that has any other regular or irregular shape. In some embodiments, the area of a display that an item of content occupies may vary over time. For example, the content may start as a small point and grow to occupy half of the screen.

The dimensions of an item of content may be indicated in various ways, according to various embodiments. Content dimensions may be indicated in terms of pixels, inches, centimeters, other units of measurement, dots, scan lines, or in terms of any other units. In various embodiments, stored content dimensions may represent required dimensions. For example, content must be presented where it occupies a portion of a screen five inches wide and three inches tall. In some embodiments, stored content dimensions may represent preferred dimensions. In some embodiments, stored content dimensions may represent maximum or minimum constraints on dimensions. For example, a field in content database 224 may indicate minimum dimensions at which content must be displayed. However, it may be permissible to display content at larger dimensions.

In some embodiments, the dimensions of content may be indicated in terms of a proportion. The proportion may indicate, for example, the ratio of the length of the content to the width of the content. It may then be permissible to display the content at any absolute size so long as the ratio of its length to width falls in line with the desired proportions.

Field 636 may indicate the originator of content. The originator may be a company, government entity, place of worship, club, non-governmental organization, charity, person, or any other entity. The originator may or may not be the owner of digital signage system 100. The originator may or may not be the operator of digital signage system 100. The originator of the content may be an advertiser wishing to promote certain products or services using digital signage system 100. The originator may be a government organization wishing to make a public announcement using digital signage system 100. The originator may have a variety of purposes for having the corresponding content displayed on, stored on, and/or available to digital signage system 100. The originator may have paid money to have the content played and/or available for play on the digital signage system 100.

Field 640 may include an indication of the nature of a given item of content. For example, field 640 may indicate that the content is an advertisement, a public announcement, an informational piece, an item of general entertainment (e.g., a situation comedy), or any other type of content.

Field 644 may include an indication of the target audience for a given item of content. The target audience may have been specified by the originator of the content, for example. The target audience may represent preferred or desirable viewers for the content. An indication of a target audience may include an indication of a: (a) gender; (b) age; (c) occupation; (d) marital status; (e) income level; (f) geographic location; (g) number of children that an audience member would have; (h) religion; (i) race; (j) nation of origin; (k) language spoken; (l) height; (m) weight; (n) medical status; (o) hobby (e.g., a target audience member would enjoy mountain biking); (p) criminal status; (q) home ownership status; (r) car ownership status; (s) citizenship; (t) citizenship status (e.g., naturalized; e.g., permanent resident; e.g., non-citizen); (u) educational status; (v) political affiliation; (w) product ownership status (e.g., a target audience member would own a cell phone); and/or any other demographic or other characteristic.

Field 648 may include actual data that makes up the content. For example, field 648 may include data in compressed or uncompressed format that can be used to create (or recreate) an image, video, audio, or other presentation. In some embodiments, field 648 may include a pointer to a computer memory address (e.g., to a computer memory address of the server; e.g., to a computer memory address in a separate device). In some embodiments, field 648 may include a pointer to an external device or location. For example, content need not be stored directly on or at server 104. Rather content may be stored on an external server, computer, hard drive, or other memory device. Field 648 may provide an indication of where and/or how to retrieve such content.

Though not indicated explicitly, it should be understood that in various embodiments, content database 224 may include various other types of data or information. In some embodiments, content database 224 may include information related to layering or transparency. In some embodiments, it may be possible or permissible to display one item of content on top of another. The topmost content may be semi-transparent, so that both items of content are visible. Thus, in various embodiments, content database 224 may indicate that a certain item of content may be displayed while layered above or beneath another item of content.

In various embodiments, content database 224 may indicate a position on a display screen where content is to be displayed. For example, the content may indicate that a ticker is to be displayed at the bottom of a display.

In some embodiments, content database 224 may indicate other preferred, desirable, or required display characteristics for content that is shown on a particular display. For example, content database 224 may indicate that a particular item of content is only to be displayed on a display from a certain manufacturer. In some embodiments, content database 224 may indicate that content is to be displayed only on displays that are at a certain height (e.g., eye level). In various embodiments, content database 224 may specify any other restrictions as to which displays are to be used for displaying content.

Content database 224 may be used in various embodiments. Content database 224 may provide information useful for scheduling when and where content should be played. For example, the target audience field 644 may be used to schedule a particular item of content only on displays which serve the relevant target audience. As another example, dimensions field 632 may show that a given item of content can be played at the same time on the same display as another item of content because they will both fit on the screen at the same time. The playing time field 616 may be used to schedule several items of content to play consecutively on a given display so as to completely fill a 10-minute content loop. The originator field 636 may allow the digital signage system to fulfill quotas, for example. For instance, the digital signage system may be contractually obligated to play content from a particular originator at least one thousand times during a given month. The originator field 636 may also allow digital signage system 100 to avoid playing consecutive content items from competing originators. For example, the digital signage system may avoid playing, on the same display, consecutive or concurrent ads from both Coke and Pepsi.

The content nature field 640 may allow for an appealing mix of content to be scheduled. For example, it may be determined (e.g., through survey or observation) that viewers pay more attention to signs that alternate informational and advertising content than to signs that play only advertising content.

The frame rate field 628 may ensure that content is played at the proper rate. The frame rate field 628 may further ensure that content is played only on displays that are capable of the required rate. The display restrictions field 624 may ensure that content is only scheduled to be played on displays that meet the indicated restrictions.

The external data source field 620 may provide a reference location, address, or other source from which to obtain content that may not be directly available from server 104.

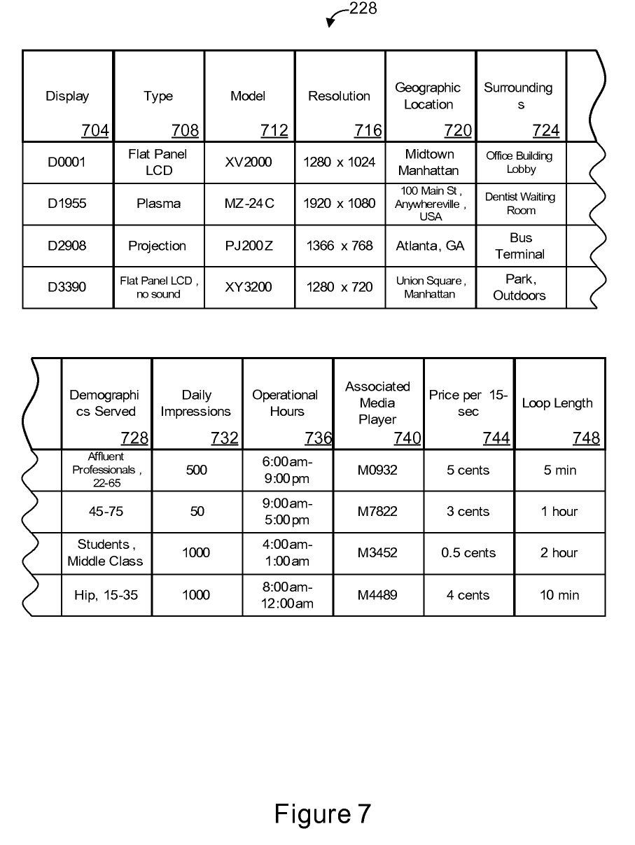

FIG. 7 depicts a representation of display database 228 according to some embodiments. Display database 228 may include various information about one or more displays in digital signage system 100. In various embodiments, the information stored in database 228 may aid in the scheduling of content to be played on one or more displays in digital signage system 100.

Field 704 may include an identifier (e.g., D0001; e.g., D2908) that may serve to identify and/or refer to a particular display. Field 704 may include information about the type of display (e.g., flat panel; e.g., projection). Field 712 may include information about the model of the display. Field 716 may include information about the resolution of the display. For example, field 716 may include information about a number of scan lines, a number of pixels, pixel dimensions, or about anything else pertinent to the resolution of a display.

Field 720 may include information about the geographic location of a display. Such information may include a country, city, state, county, town, village, neighborhood, a landmark reference (e.g., an airport; e.g., a park), a distance from a landmark, a block, a street address, a floor in a building, latitudinal and longitudinal coordinates, GPS (global positioning system) coordinates, an elevation, or any other indication of geographical location, or any other indication of location.

Field 724 may include information about the surroundings in which a display is situated. Such information may describe whether the display is indoors or outdoors, whether the display is in strong or weak ambient light, what type of business the display is in, how noisy the surroundings are, or any other information about the surroundings.

Field 728 may include information related to the type of audience served by a given display. Field 728 may include information about the age, race, income, nationality, marital status, and any other information, including any demographic information, or any other information. Field 728 may include information about some segment or portion of an audience that may view a display. For example, if most of the audience for a display falls within a certain age range (even though the entire audience does not), then that age range may be listed in field 728. In various embodiments, field 728 may store information about several audience segments for one display. For example, a display may serve an area where there are a number of teenagers and a number of professional adults as well. Information about both these groups may be stored in field 728. In some embodiments, where there are multiple audience segments served, the relative numbers or proportions of people in these different segments may be noted (e.g., 40% teenagers and 60% professional adults).

Field 732 may include information related to the number of times that a given display is viewed per day. It will be appreciated that, in various embodiments, the information may be couched in terms of some other unit of time, such as per hour or per week. In some embodiments, display database 228 may include an indication of how many people pay actual attention to a display per unit of time. People may be deemed to pay attention, for example, if they fix their gaze on the display for more than a predetermined period of time (e.g., for more than 1 second), if they can later recall something they saw on their display, if they turned their head because of the display, or if some other criterion (or criteria) is satisfied. The information stored in field 228 may be determined in various ways. In some embodiments, an observer may observe and count directly the number of people to view a display. In some embodiments, indirect measurements may be used.

For example, the number of viewers for a display located in a bus terminal may be estimated based on the number of passengers known to be arriving and departing from the bus terminal each day (e.g., based on ticket sales).

Field 736 may include information related to the operational hours of a display. Field 736 may include a schedule of daily operational hours, a schedule of weekly operational hours, a monthly schedule of operational hours, or any other schedule. Operational hours may represent, for example, times when a display is on, times when there are any audience members to view a display, times when advertising slots are being sold on the display, or any other situation. For example, a display located in a retail store may be operational during the business hours of the retail store, but may be turned off otherwise.

Field 740 may include information about an associated media player. An associated media player may be a media player that provides the signals to be used on a given display. In some embodiments, a display may have more than one associated media player. For instance, the display may be operable to use signals from either media player. In some embodiments, a display may have no associated media player. For example, the display may include an integrated media player.

Field 744 may include pricing information related to the use of a particular display. Pricing information may represent the amount of money an advertiser would be charged for having its ad shown on the display for a given period of time (e.g., for 15 seconds). Pricing may also apply to other content providers. In some embodiments, there may be different pricing for different types of content providers. For example, advertisers may be charged a first rate, charitable organizations may be charged a second rate, and governmental entities may be charged a third rate.

In some embodiments, the price to show content may depend on various factors. The price may depend on the amount of screen space used. For example, content that takes up a quarter of the screen may be priced lower than content that takes up half of a screen. However, in various embodiments, pricing need not be directly proportional to the screen space occupied (e.g., there may be a bulk discount). The price of content may be based on a number of other factors, including time of day, weather, foot traffic (i.e., number of people passing the sign per unit time), season, demographic characteristics of passers by, and/or based on any other factors.

Field 748 may include information about a loop length. A loop length may represent a period of time, after which content played on a display will be repeated. For example with a loop length of five minutes, content played on a display may be repeated every five minutes.

Information stored in display database 228 may have various uses. For example, an advertiser may wish for its content to be displayed in particular geographic locations (e.g., if the advertisers is a local business), in particular surroundings (e.g., to provide a particular ambience for the advertisement), and to particular demographics (e.g., to the demographics that the advertiser believes will most likely purchase the advertiser's product). In various embodiments, an advertiser may wish for its ad to be viewed a certain minimum number of times per day. Ad advertisers may also have preferences for how frequently its ad is repeated. For example, an advertiser may prefer a display with a loop length of thirty minutes versus a display with a loop length of five minutes. In various embodiments, an advertiser may have a particular budget and may thereby be concerned with the price it will have to pay for displaying ads. Information stored in display database 228 may also be used to determine whether a display is capable or suitable of playing particular content (e.g., whether a display is capable of playing content that requires a certain resolution). Information stored in display database 228 may aid in the diagnosis and correction of problems. For example, with reference to the model number of a display, an appropriate technician may be consulted in the event of a malfunction with the display.

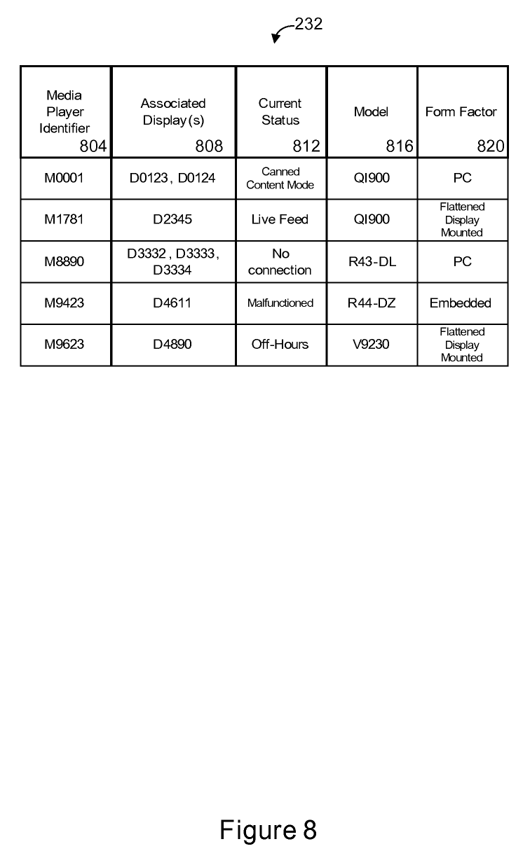

FIG. 8 depicts a representation of media player database 232 according to some embodiments. Media player database 232 may include various information about one or more media players in digital signage system 100. Field 804 may include identifiers for media players. An identifier may be used to identify and reference a particular media player.

Field 808 may include information about associated displays. A given media player may provide signals (e.g., video signals; e.g., audio signals) for one or more (e.g., for all) of the associated displays. Field 812 may include information about the current status of a media player. For example, a media player in “canned content mode” may cause an associated display to repeatedly play the same loop of content stored locally on or near the media player. The media player may lack a current connection to the Internet, for example, and may thereby be looping only locally stored material. A media player with a status of “Live Feed” may currently be playing and/or receiving data via a network. Thus, the media player may continually be playing new content, such as new news headlines or live television programming. Field 816 may include an indication of a model, which may be used, for example, to determine the capabilities of a given media player, or to track down the source of a potential malfunction. Field 820 may include an indication of a form factor. For example, a media player that is implemented as a separate hardware device may take various forms. In some embodiments, the media player may be a standard personal computer (PC). In some embodiments, the media player may be made with a special shape. The shape may be complementary to the shape of a display, so that the media player may fit flush against the display. For example, the media player may be flattened to fit against the back of the display, so that together both are still relatively thin. In some embodiments, a media player may be attachable or mountable directly on a display. For example, a display may include hooks or latches where a media player can attach.

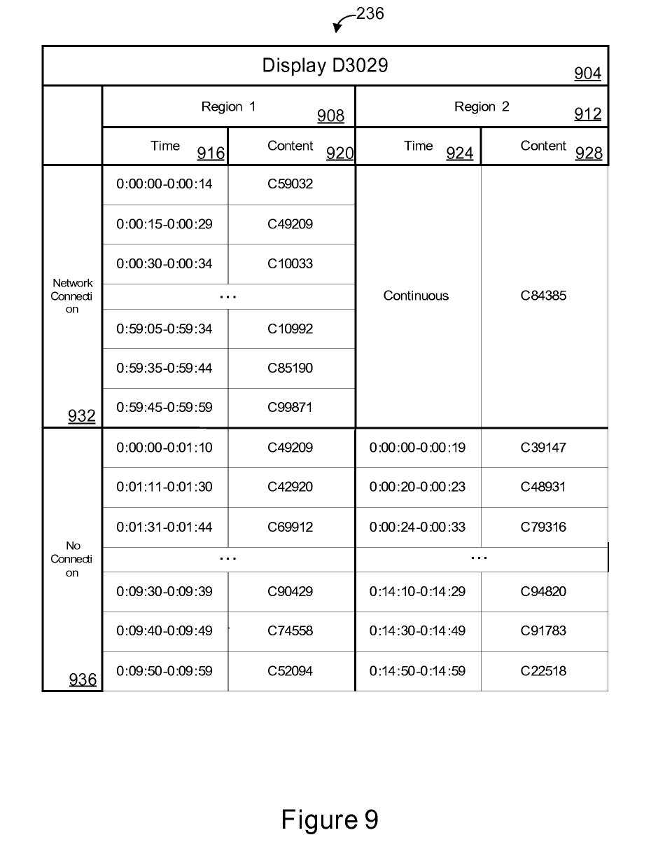

FIG. 9 depicts a representation of an entry in a scheduling database 236 according to some embodiments. In various embodiments, a scheduling database may include an entry for each of one or more display in digital signage system 100. The scheduling database may store an indication of what content is to be played on a given display. The scheduling database may store an indication of when a given item of content will be displayed on a given display. The scheduling database may store an indication of where a given item will be stored on a display (e.g., on what region of the display).

Field 904 may include an indication of a display (e.g., display D3029). Other scheduling information stored in the database entry 226 may apply to the display indicated in field 904. Fields 908 and 912 correspond to different regions on the display. For example, a display may include one, two, three, or more regions. Within each region separate items of content may be shown, so that if there are multiple regions, items of content may be shown simultaneously. Thus, for example, the left half of a display may show a live video broadcast, while the right half of the display may show still-image advertisements. Although FIG. 9 depicts a database entry in which there are two region fields, it will be appreciated that, in various embodiments, an entry may include more or fewer region fields.

In various embodiments, corresponding to a given region field, there may be a time field and a content field. In FIG. 9, time field 916 may correspond to region 1 field 908. Similarly, content field 920 may correspond to region 1 field 908. Entries stored under time field 916 and content field 920 may indicate a particular period of time (e.g., 0:00:00-0:00:14) and a particular item of content (e.g., C59032) that will play during that period of time. Thus, for example, content item C59032 may be scheduled to play in region 1 of display D3029 during the time period 0:00:00-0:00:14. The time period indicated may be relative to a reference time. For example, the time period 0:00:00-0:00:14 may indicate the first 15 seconds of operation for the day, or the first 15 seconds of a loop.

Database entry 236 may also include a Network Connection field 932, and a No Connection field 936. According to various embodiments, a display may play a first set of content when there is a network connection (e.g., a connection to server 104), and may play a second set of content when there is no connection. With a network connection, a display (or its corresponding media player) may periodically receive new content, or may receive a continuous stream of new content. Thus, the display may play new content when there is a network connection, in various embodiments. When the display does not have a network connection, the display may play content that is stored locally (e.g., in a computer memory associated with the display or its associated media player). The display may continue to play such content (e.g., continually repeat the content), until it connects to the network again. It will be appreciated that, in various embodiments, a display may receive new content even without a network connection. For example, a human being may connect a portable storage device containing new content to the display or to its associated media player.

As depicted in FIG. 9, for each region (e.g., region 1 908 and region 2 912), there is a first schedule for content if there is a network connection (e.g., there is a first schedule corresponding to Network Connection field 932), and there is a second schedule for content if there is no network connection (e.g., there is a second schedule corresponding to No Connection field 936).

In embodiments depicted in FIG. 9, various content is scheduled to play for an hour in region 1 of the display when there is a network connection. At the end of the hour, the loop may start over and content may be played from time 0:00:00 again (e.g., content item C59032 may be played again). In some embodiments, at the conclusion of the hour, new content may be downloaded to the display (or to its associated media player, or to a local memory, or to some other device). The new content may then be played. In some embodiments, one or more schedules stored in conjunction with a display may represent content that will be played going forward. As each item of content is played, the schedule may be updated. For example, the second item of content may become the first item, the third may become the second, etc., and a new item of content may be added at the end of the schedule.

In embodiments depicted in FIG. 9, one hour's worth of content is scheduled on region 1 if there is a network connection. However, if there is no network connection, then ten minutes of content is scheduled on region 1. In some embodiments, if a network connection goes down while content from the Network Connection schedule is being played, then the display may switch over to the content on the No Connection schedule.

In embodiments depicted in FIG. 9 region 2 may have scheduled continuously running content. For example, such content may include a live television broadcast. However, if the network connection goes down, then region 2 may play a 15-minute loop of content.

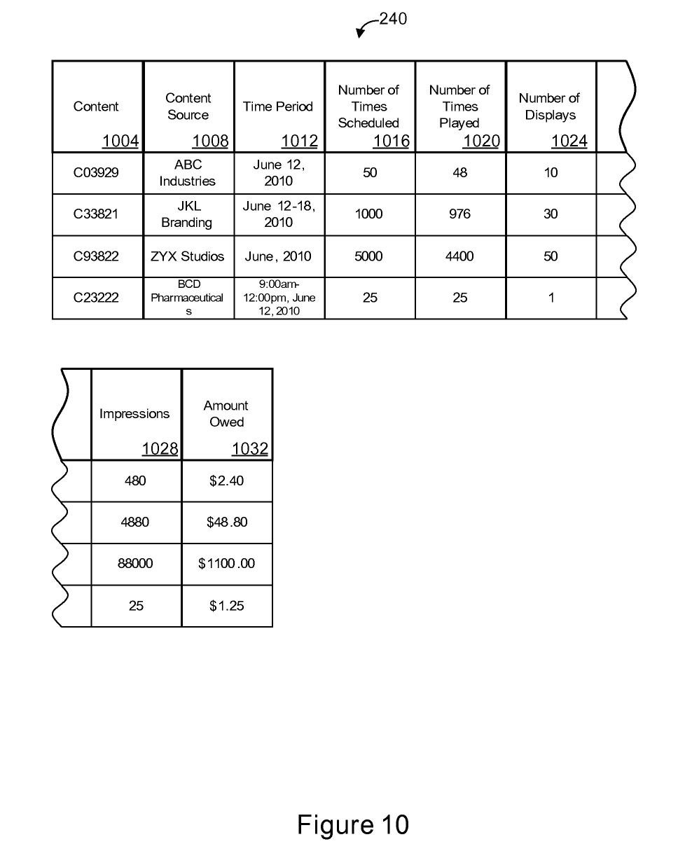

FIG. 10 depicts a reconciliation database 240 according to some embodiments. In various embodiments, reconciliation database 240 may reconcile the number of times content was scheduled to be played on digital signage system 100 with the number of times the content was actually played. In various embodiments, reconciliation database 240 may track how much money is owed to the owner or operator of digital signage system 100 based on how often content was played, based on a number of impressions, or based on any other factor.

Field 1004 may store a content identifier. Field 1008 may store an indication of the source of the content. The source of the content may be an advertiser who is paying to have the content shown on digital signage system 100. The source may also be a government agency or any other source.

Field 1012 may store a time period. The time period may represent a time period during which the playing of content has been, is being, or will be tracked. Field 1016 may store a number of times that a particular item of content has been scheduled for play (e.g., across the entire digital signage network 100; e.g., across some subset of displays in digital signage network 100). Field 1020 may store a number of times that a particular item of content has been played (e.g., across the entire digital signage network 100; e.g., across some subset of displays in digital signage network 100). Field 1024 may store a number of displays on which a given item of content has been played (e.g., during the time period listed in field 1012). Field 1028 may store a number of impressions that a given item of content has made. Field 1032 may store an amount owed to the owner or operator of digital signage network 100, e.g., by virtue of the number of times an item of content has been played.

It will be appreciated that reconciliation database 240 may store other data, in various embodiments. In some embodiments, reconciliation database 240 may break down the number of times an item has been played by display, by type of venue, by hour of the day, or according to any other factor. For example, reconciliation database 240 may indicate how many times an item of content has been played during rush hour, and how many times the item of content has been played during other times. The breakdown of the number of times an item of content has been played may factor into the price charged to a provider of the content (e.g., a provider may be charged more when content has been played during rush hour than when content has been played during slower hours).

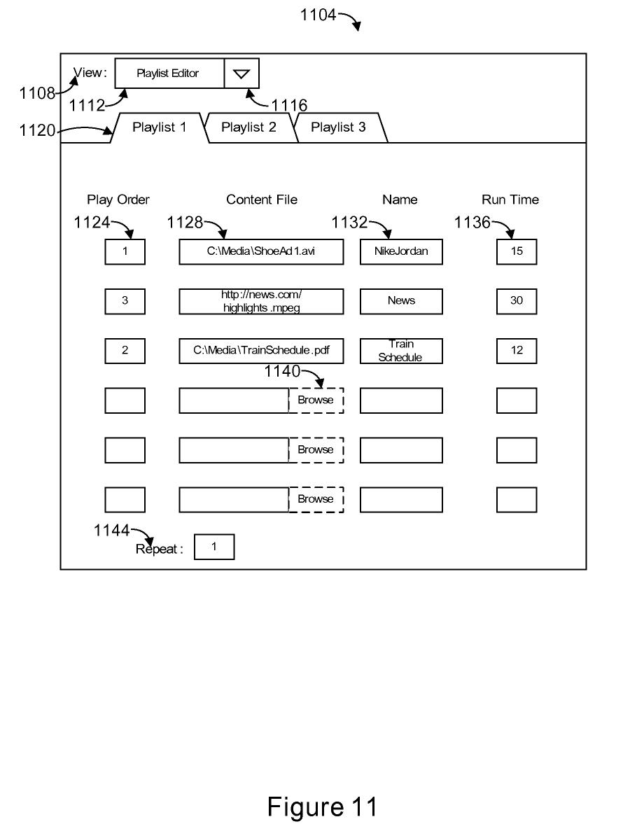

FIG. 11 shows a portion of a user interface, according to some embodiments. The portion of the user interface shown 1104 may allow a user to load various items of content. For example, the user may load images, text files, animations, video, or any other item of content. The user may load such content from any suitable location. For example, the user may load files from a computer he is using (e.g., from computer 152), from another computer on a network, from a remote computer or server on the Internet, from a storage medium (e.g., from a compact disc; e.g., from a USB drive), or from any other location. In loading content, a user may cause such content to be stored in a particular location, such as on a server (e.g., server 104), on a computer (e.g., on computer 156), on a media player (e.g., on media player 136), on a display (e.g., on display 132), or in any other location.

To load content, a user may enter into the user interface location information for the content and/or an identifier for the content. For example, the user may enter a folder on his computer where the content may be found, and may also enter the file name of the content. In another example, a user may enter the Web address where the content may be found, and may further enter the file name of the content. Field 1128, and similar fields, allow the user to enter location information. In some embodiments, a user may press a “browse” button (e.g., button 1140), which may bring up a window for examining files and folders on the user's computer and which may allow the user to conveniently designate folders for finding the content, as well as the content file itself.

In various embodiments, once an item of content has been loaded, a user may enter additional information about the content. For example, the user may enter a convenient name by which to identify the content (e.g., in field 1132). A user may enter the originator of the content or the target audience for the content. In various embodiments, additional information about the content may be determined automatically, e.g., from the content file itself. For example, a playing time for the content, or a file type for the content may be determined automatically. The determination may be made, for example, from the content file's name (e.g., from a file extension designating the content type), or from header information within the content file.

In some embodiments, actual content need not be loaded. Rather, the actual content may be stored at some other location. In some embodiments, an indicator or address of content may be designated. In the future, when the actual content is required (e.g., when actual images are required for playing on a display), the actual content may be downloaded or otherwise obtained from the address. Providing a location or indicator of content rather than actual content may be appropriate for content that is to be real-time, such as stock quotes or news headlines.

For an item of content loaded or designated, a database record or entry may be made. The record or entry may be stored in content database 224, for example.

With content loaded or designated, a user may then arrange various items of content into sequences. These sequences or lists of content may be referred to as “channels”, “playlists”, or by some other terminology. A playlist may comprise one or more items of content together with some designated order for the items of content. For example, a playlist may comprise content items A, B, C, and D in the following order: C, B, A, D. A playlist may, in various embodiments, include a single item of content that is repeated multiple times in the order. For example, a playlist may comprise content items A, B, C, and D in the following order: A, B, C, A, D, B, C, A, D. In various embodiments, a user may enter a playing order for content within a playlist by entering a number in field 1124. For example, by entering the number 1 in field 1124, a user may indicate that the corresponding content is to be played first within a playlist.

In various embodiments, a first playlist may contain a second playlist. For example, playlist A may contain playlists B and C. In this example, playlist A may thereby contain all items of content in playlist B and all items of content in playlist C. In various embodiments, a playlist may be formed from one or more other playlists together with one or more other items of content. For example, playlist A may contain playlist B and content item X. As will be appreciated, in various embodiments, playlists can be nested within one another to arbitrary depth. For example, playlist A may contain playlist B, which may contain playlist C, which may contain playlist D, and so on. By forming a first playlist from a second playlist, a user may more quickly form playlists and/or may form playlists using more manageable “blocks” of content, rather than working with numerous individual items of content.

In various embodiments, program logic may prevent the creation of infinitely nested playlists. For example, suppose playlist A contains content item X and playlist A. Thus, actually playing playlist A would cause content item X to be played repeatedly, without end. Thus, in various embodiments, program logic may prevent a playlist from containing itself. In various embodiments, program logic may prevent a first playlist from containing any other playlist which contains the first playlist. In various embodiments, program logic may prevent a first playlist from containing any playlist which contains the first playlist, either directly or indirectly (e.g., through a chain of one or more other playlists).

A playlist may further comprise playing times for various items of content. For example, one item of content in a playlist may be a static image. In some embodiments, when a user creates a playlist, the user may designate how long the image is to be displayed before the next item of content is displayed. In some embodiments, the playing time of an item of content is already designated or determined as part of the content item itself (e.g., a particular static image is always played for five seconds, and such playing time is indicated in content database 224). In some embodiments, the designation of a playing time may be useful for content of a real-time nature. For instance, real-time weather information may play for 10 seconds before some other content is played. In some embodiments, a playing time for content may be entered, either by the user or automatically, in field 1136.

In various embodiments, a playlist may comprise contingency features, control features, and/or any other features or commands. For example, a playlist may comprise a repeat feature. With a repeat feature, once all content in a playlist has played, the content may repeat, starting from the first item of content in the playlist. In some embodiments, a playlist may repeat content a certain number of times (e.g., five times), before the content will no longer be played. In some embodiments, the playing of a playlist may be contingent on some event. For example, a playlist may be played only if a particular team wins the Super Bowl. In some embodiments, a user may input or select control features for a playlist when creating the playlist. For example, a user may enter a number of times to repeat in field 1144. In some embodiments, a user may input or select control features at a later time (e.g., when the user is designating a playlist to be played on one or more displays).

In various embodiments, there may be multiple playlists. For example, a user may create multiple playlists. Each playlist may comprise different items of content, or the same content in different orders, or the same content but with different playing times, or any other variations. A user may work with different playlists in the portion of the user interface 1104 by navigating through different tabs. Tab 1120 brings up “Playlist 1”. However, the user may work with other playlists by selecting different tabs.

In addition, in various embodiments, the user may wish to work on other portions of the user interface. The view 1108 shown in FIG. 11 may represent the playlist editor, as indicated by menu item 1112. However, in various embodiments, a user may manipulate arrow 1116 to select other menu items, and therefore other portions of the user interface.

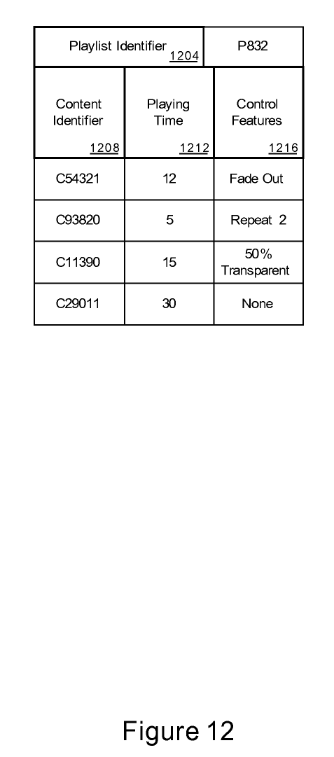

As a user creates a playlist and determines the items of content to be in the playlist, information about the playlist may be stored in a playlist database. FIG. 12 shows an entry 1200 in a playlist database, according to some embodiments. Field 1204 may store a playlist identifier which may be used to uniquely identify a playlist, in some embodiments. Field 1208 may store content identifiers. Each content identifier may indicate an item of content that makes up the playlist. In some embodiments, the order in which the content identifiers are stored indicates the order in which the corresponding content will be played. Field 1212 may be used to store playing times. For example, static images may be given a particular length of time to be displayed before the next item of content in a playlist is displayed. Field 1216 may be used to store control features, according to some embodiments. Control features may indicate the manner in which content is to appear and disappear (e.g., the content may fade in or fade out), the number of times an item of content is to be repeated (e.g., an item of content may be played twice within a playlist), the visual effects applied to content (e.g., the content may be made transparent; e.g., the content may be tinged red; e.g., the content may be shown with increased contrast), or any other manner in which content is to be played, or any other manner in which content is to be handled.

In various embodiments, playlists may be part of a schedule, possibly together with individual items of content. For example, the entry 236 in the scheduling database entry 236 of FIG. 9 may list playlists in addition to, or in lieu of individual items of content.

In various embodiments, a user may designate the locations on a display where certain content and/or where certain playlists are to be displayed. For example, a user may cause the content of a particular playlist to be displayed in the upper left quadrant of a rectangular display screen.

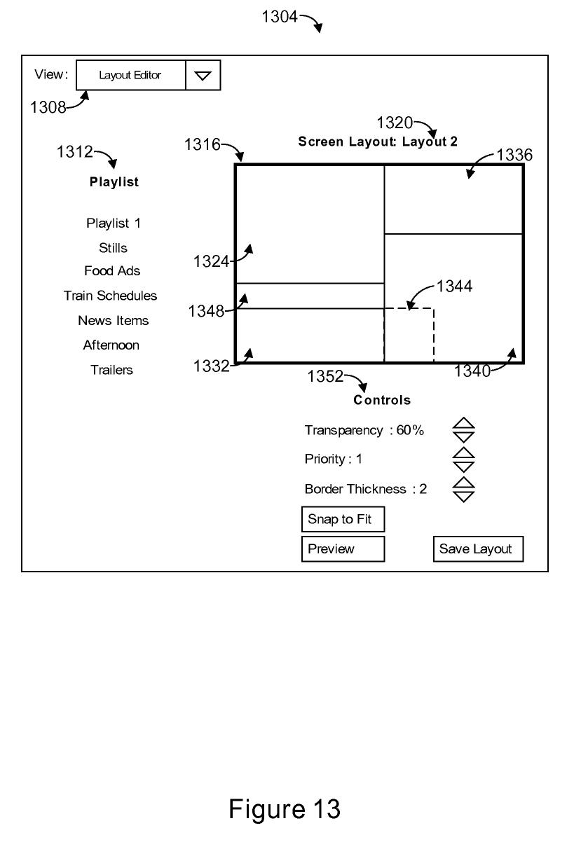

FIG. 13 shows a portion of a user interface which may be used to designate the locations on a display where content and/or playlists are to be displayed. In some embodiments, a rectangular region 1316 represents an actual display. The user may create smaller rectangles (e.g., rectangles 1324, 1332, 1336, 1340) or other shapes within region 1316 to indicate and delineate where certain content and playlists will be played.

The user may designate rectangular regions within region 1316 in various ways. For example, the user may move a mouse pointer to one location within region 1316, click the mouse, and then drag the mouse to another location within region 1316. The starting and ending points of the mouse pointer may correspond to diagonally opposite corners of a newly formed rectangular region (e.g., region 1324). A rectangular region that has already been formed may be resized by clicking on and dragging one of the corners or one of the edges, for example. In some embodiments, a rectangular region (e.g., region 1324) may be moved within region 1316 by clicking on the region (e.g., region 1324) and moving it within region 1316.

As will be appreciated, there may be many other ways to form, resize, or move regions such as region 1324. Further, in various embodiments, a user may create regions of shapes other than rectangular shapes. For example, a user may create a region shaped like a circle, a triangle, a guitar, or any other shape. In some embodiments, the region representing the whole display (i.e., region 1316) need not be shaped like a rectangle. For example, the display being represented may be built in the shape of a circle. Thus, region 1316 may be shaped like a circle.

### Snap to Fit

In various embodiments, a user may create rectangular regions (e.g., region 1324) within the larger region 1316. Depending on the user's efforts or hand dexterity, for example, the regions that a user creates will not necessarily occupy the entirety of region 1316. In other words there may be some empty space in the region representing the whole screen (e.g., region 1316) that is not occupied by user-created regions for displaying content. For example, the space indicated by reference numeral 1348, although surrounded by regions 1324, 1332, and 1340, is not occupied by any user-created region. In some embodiments, when there are empty spaces, the user-created regions may automatically expand and/or resize in such a manner as to fill one or more empty spaces. For example, suppose that the user starts with region 1316 completely empty, and then the user creates a first region that fills the entire left third of region 1316, and a second region that fills the entire right third of region 1316. If the user creates no other regions, then the middle third of region 1316 may be left empty. Thus, in some embodiments, the first region may be automatically expanded to fill the left half of region 1316, and the second region may be automatically expanded to fill the right half of region 1316, thus eliminating the empty space in the middle of region 1316. It will be appreciated that, in some embodiments, more complicated resizings may be necessary for filling in empty spaces. For example, in some embodiments, a given user-created region may be shrunk along one dimension, but expanded along another dimension.

In some embodiments, a user may affirmatively issue a command for the user-created regions to fill in empty spaces (e.g., in region 1316). For example, the user may click on one of the controls 1352 marked “Snap to Fit” or similarly marked controls, in order to cause a particular region to change shape so as to fill in empty spaces (or eliminate overlap) within region 1316. In some embodiments, the user-created regions may fill in the empty spaces even without a user command. For example, when a user clicks a button marked “done” or otherwise finishes creating regions, those that have been created may automatically be resized to fill in empty spaces within region 1316.

In some embodiments, other characteristics of a region may be designated or determined. For example, a user may designate characteristics of a region. In some embodiments, one or more regions may overlap. In some embodiments, a first region may be created entirely on top of a second region. Thus, in some embodiments, a characteristic of a region may be its priority for display in the event that it overlaps with one or more other regions. For example, regions may be given numerical priorities, and in the event of an overlap between two regions, the region with the highest numerical priority may have its full content displayed. In some embodiments, numerical priorities may be indicated visually with colors, grayscale levels, patterns, or other visual indicators. For example, a region of higher priority may be shown visually as darker gray than a region of lower priority.

The content in the region with the lower numerical priority may be cut off by the content from overlapping region with the higher numerical priority. In some embodiments, when two or more regions overlap, the content in one or more of the regions may be resized (e.g., shrunk) so that one item of content does not overlap with another item of content. The content that is resized may correspond to content in a region with lower priority. In some embodiments, when two or more regions overlap, one or more regions (e.g., one or more of the overlapping regions; e.g., one or more of any user-created region, even if it does not over lap) may be moved or resized in order to reduce or eliminate the overlapping portion between the two or more regions. For example, suppose the user creates a first region that occupies the leftmost two thirds of the full display region (e.g., region 1316) and a second region that occupies the rightmost two thirds of the full display region. The first and the second region will thus overlap in the middle third of the full display region. According to some embodiments, the first region may be resized to occupy only the leftmost half of the full display region, and the second region may be resized to occupy only the rightmost half of the full display region. As will be appreciated, which of two or more regions is resized may depend on the relative priorities of the regions. For example, a lower priority region that overlaps with a higher priority region may be resized, while the higher priority region may remain the same size. In some embodiments, a user may designate the priority of a region using controls 1352. For example, a “Priority” control may allow a user to adjust the priority of a region, e.g., by manipulating arrows to increase or decrease the priority.

In some embodiments, one or more regions may be moved so that the overlap between them is reduced or eliminated. For example, the user may create a second region that is completely surrounded by and contained within a first region. The second region may thereupon be automatically moved so that it is no longer contained within the first region. In some embodiments, two or more regions may overlap, and the overlap may be allowed to persist. However, while using the user interface, a user may wish to see the full extent of each user-created region. If a first region were to overlap with a second region, the user might not be able to tell how far the second region extends, as the extent of the second region might be obscured by the first region. In some embodiments, the boundaries of user-created regions might be ordinarily indicated by solid lines. However, when there is overlap between two user-created regions, the portion of a first region that overlaps with another may be indicated with a dashed line. For example, in FIG. 13, region 1332 overlaps with region 1340. The portion of region 1332 that overlaps with region 1340 is indicated by the dashed line 1344. In general, in various embodiments, the boundary of a region that overlaps with another may be indicated differently for the overlapping portion. This might occur for each of two or more overlapping regions, or just for one or more regions that is deemed to lie under/behind/in the background of another region. In some embodiments, when two regions overlap, one of the regions may be made transparent or semitransparent. In this way, a viewer may see that a first region continues under a second region, rather than ending at the boundary of the second region.

In some embodiments, when two or more regions overlap, a user may indicate or command that content displayed in a first of the overlapping regions should be somewhat transparent. In this way, while content in the first region may be visible when playing, content in a second, overlapping region may also be visible. To see two sets of content overlaid on top of one another may create an interesting or pleasing visual effect. In some embodiments, a user may indicate or designate that a certain region should show content that is somewhat transparent, even if the region does not overlap with another region. In this way, content may be given a ghost-like effect, for example. In some embodiments, a user may use a control 1352 labeled “Transparency”, or similarly labeled, in order to adjust the transparency of a region (e.g., of content shown within the region).

In various embodiments, a user may provide that content in a region have various levels of transparency. For example, a user may indicate that content should have 50% transparency. In another example, a user may indicate that content should have 80% transparency.

In some embodiments, a user may assign or create other characteristics for a region. For example, a user may assign a fading characteristic for region borders. With a particular fading characteristic, content, at its borders, may become more and more transparent, so that at the very edge of the region the content becomes almost fully transparent. A user may, for example, assign a characteristic to a region which says how far within the region the fading effect will begin. Note that a different and distinct “fading” effect may describe the way content appears and disappears. Thus, for example, “fading” may alternately refer either to the way content changes over time, or to the way content changes as a function of position (e.g., as a function of distance to the border of a region).

In some embodiments, a user may assign certain borders to a region. For example, a user may indicate that a region is to have a white border of a particular thickness. Thus, any content to be displayed within that region may have to be displayed not only within the region, but also within the border. In some embodiments, a user may employ a control 1352, such as a “Border Thickness” or similarly labeled control to set the thickness of a border to a region.

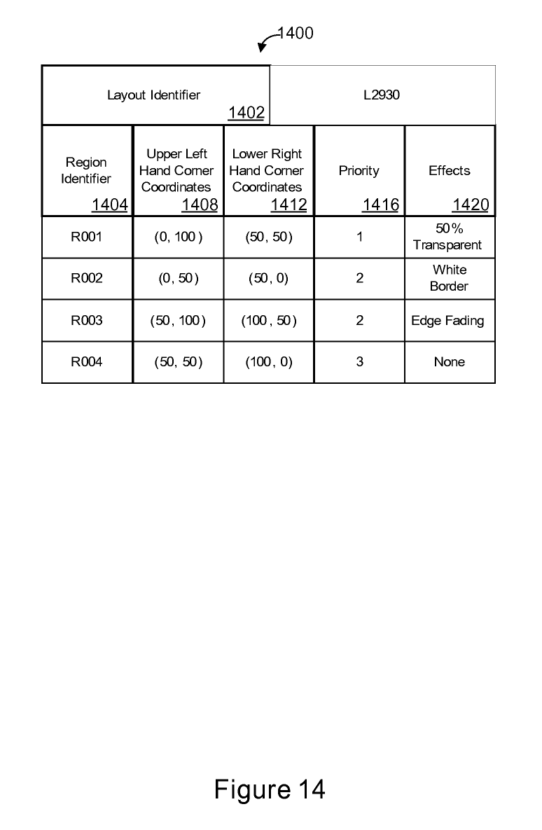

As will be appreciated, many other effects or characteristics may be assigned to a given user-created region. Characteristics assigned to a region may be stored in a database, such as a layout database, an entry 1400 of which is shown in FIG. 14. A user may press a “Save Layout” or similarly labeled button in order to save a particular layout (e.g., a particular arrangement of regions; e.g., a particular arrangement of regions with corresponding characteristics for the regions).

FIG. 14 shows an entry 1400 in layout database 244, according to some embodiments. The entry may represent information about one particular layout (e.g., about the layout corresponding to field 1402). The entry in the layout database may store information about user-created regions in which content is to be displayed on a larger display. Entry 1400 may store such information as the location of user-created regions and various characteristics that have been assigned to the regions. Field 1404 may indicate a region identifier. The region identifier may be used, for example, to uniquely identify a particular region. Field 1408 may indicate x-y coordinates of the upper left hand corner of the user-created region within the overall display region (e.g., within region 1316). Field 1412 may indicate the lower right hand x-y coordinates of the user-created region. Field 1416 may indicate the priority. The priority may, for example, aid in the determination of whether the instant region should be in view or should be hidden in the event of an overlap with another region. Field 1420 may indicate one or more effects that should be applied to the region.

In some embodiments, effects or characteristics are not permanently tied to a particular user-created region. In some embodiments, the effects applied to the content in a region vary based on the content itself. For example, when a first item of content is played in a region, the content may be played with no effects. However, when a second item of content is played in the same region, the second item of content may be played with 50% transparency. Thus, in various embodiments, effects may be tied to items of content rather than to regions. In some embodiments, an effect depends on both content and region. For example, a given item of content will have a certain effect only when it is played in a certain region.

In various embodiments, a user need not create regions from scratch. In some embodiments, there may be templates where various regions have already been created and arranged within the larger display region. A user may pick a template that suits his needs. In some embodiments, a user may pick a template and then further refine it. For example, a user may choose a template with regions already delineated, but may then attach customized characteristics to each region (e.g., custom border effects).

In some embodiments, a user may save a particular layout of regions and then use it later. In some embodiments, a first user may use a layout that has been saved by another user.

Dragging Playlists into Regions

In various embodiments, once one or more content regions have been defined, a user may indicate what content is to play in these regions. There may be various ways of matching content with regions, in various embodiments.

In some embodiments, the user interface may display a list of playlists 1312. The playlists may be listed by name or identifier. In some embodiments, an icon is used to represent a playlist. The user may, for example, drag and drop the names of playlists (e.g., playlists from the list 1312), or icons representing the playlists, into one or more regions (e.g., into regions 1324, 1332, 1336, and/or 1340). The names of the playlists (or other indicators of the playlists, such as icons) may then appear within the regions. It will be appreciated that, in various embodiments, there may be many other ways of matching a playlist to a content region. In some embodiments, a user may match two or more playlists with a given content region. In this case, for example, the playlists may play sequentially within the content region.

In some embodiments, a user may preview how a display might look with content actually playing. For example, after a user has created one or more regions (e.g., region 1324), and after the user has designated content (e.g., playlists) for one or more of the regions, a user may employ a control 1352 labeled “Preview” or similarly labeled control. Thereupon, region 1316 may show all the designated playlists playing in all the designated regions. For example, the user may get to see four items of content playing at the same time, one in each of four regions within the larger region 1316.

### Icons

In some embodiments, for the purposes of a user interface, a playlist may be represented by an icon. The icon may be a small image. The image in the icon may be an image taken from an item of content in the playlist. Thus, in various embodiments, when a playlist is created, a program module scans through the content in the playlist and captures a frame or image from the content. The program may then shrink the frame or image down to the size of an icon. The shrinking may be accomplished using various image processing algorithms. In various embodiments, a program module may create two or more candidate icons and ask the user to select from among them. In various embodiments, a user may create his own icon, e.g., using a drawing program.

In some embodiments, there may be various size requirements for content. For example, a particular item of content may require that it be displayed in a region at least a quarter of the size of a display screen. In various embodiments, if a user matches a playlist to a content region that is not of the appropriate size for the content within the playlist, then various things might occur. In some embodiments, the content region may automatically resize in order to fit the dimensions required by the content. A user who had not been expecting the resizing might then have the opportunity to press an “undo” button or otherwise reverse the matching and have the content region revert to its previous dimensions. In various embodiments, if a user attempts to match a playlist to an inappropriately sized content region, the user may be prevented from doing so. Instead, an error or warning message may appear. The message may tell the user that the content region is the wrong size for the content within the playlist. In some embodiments, the user may be given the opportunity to change the content within the playlist (e.g., to eliminate the content item that had the stringent dimensions requirements). In some embodiments, the user may be informed what item of content is creating the conflict. As will be appreciated, many other actions may be taken in the even that a user attempts to match a particular playlist with an inappropriately sized content region. In various embodiments, other aspects of a content region may not be appropriate for certain content. For example, the border effects or the fading effects of a particular content region may be inappropriate for a particular item of content. In such cases, error messages may be displayed, the user may be given the chance to change the items of content in a playlist, or other actions may be taken.

### Display

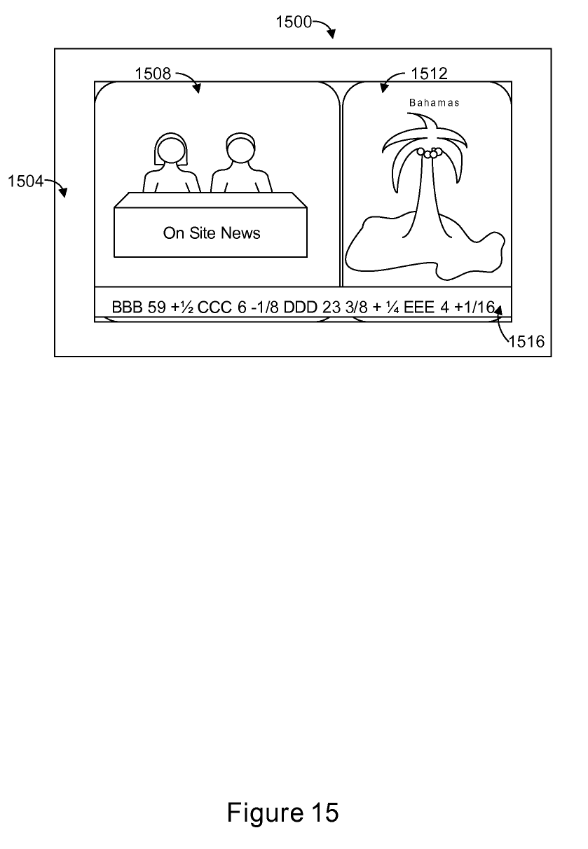

FIG. 15 shows a display 1500 according to some embodiments. A display may be a liquid crystal display (LCD), a cathode ray tube (CRT) display, a light-emitting diode (LED) display, an organic light-emitting diode (OLED) display, a projection display, a rear-projection display, a front projection display, a laser display, or any other display. The display may include a bezel 1504 surrounding a viewing area. In FIG. 15, three different content regions are visible. Region 1508 is currently playing news. Region 1512 is currently playing an advertisement for the Bahamas. Region 1516 is currently showing stock price information. Note that region 1516 overlaps with regions 1508 and 1512. Thus, the content shown in region 1516 may be shown somewhat transparently to create a visually pleasing or interesting effect. Note that the number of regions shown in FIG. 15 represents but one of many possible numbers of regions, in various embodiments. Note that the layout featured in FIG. 15 represents but one of many possible layouts, in various embodiments.

### Reconciliation Report

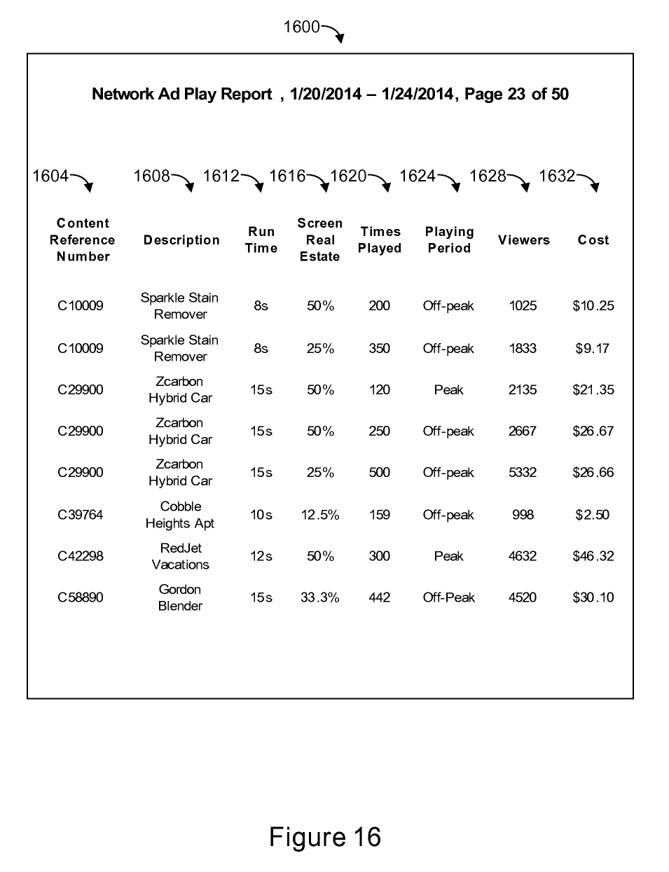

FIG. 16 shows a portion of a reconciliation report 1600 according to some embodiments. A reconciliation report may be a report that is provided to marketers who advertise on digital signage system 100. A reconciliation report may indicate various statistics about how an ad or series of ads has been shown. In various embodiments, a reconciliation report may be provided to others, including providers of content other than advertisements, including owners or part owners of system 100, including managers or operators of system 100, or including any other party. In various embodiments, a reconciliation report may serve as an invoice. For example, a reconciliation report may show an advertiser how many times their ad has played on a digital signage network and, accordingly how much the advertiser owes for having its ad played. In various embodiments, a reconciliation report may show statistics about the playing of content other than ads. In various embodiments, a reconciliation report may show any statistics related to the use of digital signage system 100 or any statistics related to digital signage system 100.

In FIG. 16, the reconciliation report is entitled “Network Ad Play Report”, though it will be appreciated that the report could have any title, or no title at all. The report 1600 also covers a particular date range, though it will be appreciated that a reconciliation report could cover any applicable or conceivable date range. The date range may represent the dates during which content covered in the report was played. Column 1604 may include reference numbers or identifiers by which to uniquely identify a particular ad or particular item of content. These reference numbers may correspond to content identifiers (e.g., from FIG. 6). Note that the same reference number may be listed multiple times. Each line for which the same reference number is listed may represent the same item of content, but a different circumstance under which the content was played. For example, a given ad may be played during peak times and during off-peak times. The advertiser may be charged different fees for peak versus off-peak airing of the ad. Thus, it may be appropriate to break out peak plays versus off-peak plays into two separate line items. Similarly, there may be different fees for playing ads on different sizes of screen real estate. For example, the fee for an ad that plays on half a screen may be more than the fee for an ad that plays on a quarter of a screen. As will be appreciated, various other circumstances under which an ad or other item of content is played may vary. In some embodiments, the fee for an ad may vary based on the length.

Column 1608 may include a description of the ad or other item of content. The description may be created by the advertiser or other party who submitted the content. The description may be created by the digital signage system owner or operator, or by any other party. Column 1612 may include a run time for the ad or other content. In various embodiments, the same ad may be played with different run times. For example, a given ad consisting of a still image may be played for five seconds in some circumstances and for ten seconds in other circumstances. Column 1616 may include a percentage or other measure of screen real estate that is to be occupied by an item of content. For example, an entry of 50% may indicate that an item of content is to occupy 50% of the screen or display area on the display on which it is played. As will be appreciated, area on which an item of content is played may be measured in terms of square centimeters, pixels, or in terms of any other metric.

Column 1620 may include an indication of the number of times a given item of content was played. This number of times may indicate the number of times the item of content was played across the whole digital signage system. Thus, for example, an item of content that has played two hundred times in total may have played ten times on each of twenty displays within the digital signage system.

Column 1624 may include a playing period. Note that, in various embodiments, different time periods during the day, during the week, during the month, or during any other cycle may be inherently more or less valuable to an advertiser or other content provider. For example, a time period during lunch hour in a restaurant may be relatively more valuable to an advertiser because the advertiser's ad may receive more views than it would at other times of the day. An advertiser or other content provider may, in various embodiments, pay different amounts to show an ad depending on the time period during which the ad is shown. Column 1624 labels playing periods as either “Peak” or “Off-peak”. These may correspond, respectively, to times of relatively high viewer traffic and times of relatively low viewer traffic. As will be appreciated, playing periods could have other labels and/or other meanings. Playing periods may labeled according to a time of day (e.g., “morning”, “evening”, “lunch”), according to day of the week (e.g., “Sunday”, “Monday”), according to the occurrence of particular events (e.g., “parade time”, “plane arrival time”, “ship docking time”), or according to any other circumstance or happening. Note, for example, that a digital sign may receive varying numbers of viewers depending on the occurrence of an event. For example, a sign at a particular location in an airport may receive relatively more viewers right after a plane has just arrived at a nearby gate. Therefore, in some embodiments, an advertiser or other content provider may pay more or less depending on the events that occur proximate in time to the playing of its content.

Column 1628 may indicate a number of viewers. The number of viewers may represent the total number of viewers who have viewed a particular ad or other item of content played under particular circumstances (e.g., during particular time periods and on a given size of screen real estate). In various embodiments, the number of viewers may be determined using models or other estimates. For example, if an advertisement is played on a digital sign inside one car in a six-car train, it may be assumed that one-sixth of the total passengers on the train viewed the advertisement. The total number of passengers on the train may, in turn, be estimated from the number of people entering and exiting turn styles at the train stations that the train has passed. In some embodiments, direct measurements of number of viewers may be used. For example, a digital sign may include a camera. The camera may pick up images from people viewing the digital sign. Image processing algorithms may then be used to determine whether people within the images are gazing in the direction of the digital sign. A person who fixes his gaze at the digital sign for more than a predetermined period of time (e.g., for more than 1 second) during the period of time when an ad is playing may be considered a viewer of the ad.

In some embodiments, algorithms may be used to determine not only whether or not a person is gazing at a digital sign, but also at what portion of the screen the person is gazing. In this way, if there are two or more items of content playing at once on a screen, it may be determined which of the two or more items of content the person is gazing at.

In some embodiments, infrared sensors near a digital sign may track passersby. In some embodiments, pressure sensors within the floor or ground may detect passersby. As will be appreciated, there may be various other ways of estimating and/or determining the number of viewers of an ad or of other content.

Column 1632 may include a cost or price. The cost may represent an amount of money being charged to a marketer or other party for using the digital signage system 100. The cost may be computed in various ways. The cost may be based on the number of times an item of content was shown, based on a time period during which the ad or other content was played, based on the amount of screen real estate occupied by the ad or other content when it was played, or based on any other criteria. In some embodiments, a cost for the playing of ads is negotiated in advance (e.g., between a marketer and an operator of the digital signage system).

As will be appreciated, the reconciliation report may be presented in various other ways. The reconciliation report may show other data, including more data, or less data. In some embodiments, a reconciliation report may be tailored for a particular marketer or for a particular other party. For example, a reconciliation report may show only the ads that correspond to a particular marketer. In some embodiments, a reconciliation report may be tailored to specifically analyze subsets of digital signage system 100. For example, a reconciliation report may be created that shows only the content that has played on displays in one particular location.

### Handling Content

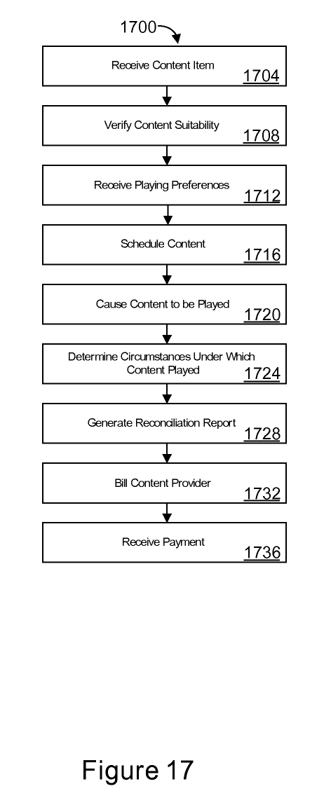

FIG. 17 shows a method for handling content, according to some embodiments. The method may be used, in various embodiments, by an operator of digital signage system 100 to receive content from an advertiser (or other party), to play the content, and to collect payment for the playing of the content.

At step 1704, a content item may be received. The content item may be an electronic file in various formats. The content item may be received over a network (e.g., via email), on a storage medium (e.g., on a compact disc; e.g., on a USB drive). The content item may be received through a Web site. For example, an advertiser may upload an advertisement using a Web site of the digital signage system. In some embodiments, a pointer or address to a content item may be received (e.g., an address for a Website containing the content may be received). The item of content may later be retrieved from the location or address.

At step 1708, the suitability of the content item may be determined. In various embodiments, a content item may be checked to ensure there is not offensive, racy, or otherwise inappropriate content. In some embodiments, a content item may be checked to ensure it is relevant to a particular audience. For example, content may be checked to ensure that it is in the language of likely viewers (e.g., Spanish versus English). In some embodiments, a content item may be checked to ensure it does not advertise a product or send a message that is contrary to the desires of a host for a digital sign (or to the desires of some other interested party). For example, if a content item is to be played within a Nike shoe store, it may be verified that the content item does not promote Reebok, a competitor to Nike. In various embodiments, the suitability of a content item may be determined automatically. For example, the text of ads may be scanned for obscene language. In various embodiments, the suitability of content may be determined via human inspection (e.g., a human may view or otherwise observe an item of content and determine its suitability). In various embodiments, a combination of human and computer or automatic verification may be used.

At step 1712, playing preferences may be received. Playing preferences may include indications of preferred times, locations, and playing frequencies for content. Playing preferences may include indications of the amount of screen real estate that an item of content should occupy (e.g., 50% of the screen; e.g., 100% of the screen). In various embodiments, playing preferences may include an indication of other content that the present item of content should not be played with. For example, a first advertiser may not wish for his ad to be played on the same screen at the same time as an ad from another advertiser. Playing preferences may include an indication of preferred viewer demographics. For example, an advertiser may indicate a preference that its ad be played only for audiences of a certain age. As will be appreciated, playing preferences may indicate various other information, such as information pertaining to the circumstances under which an ad or other item of content is to be played. In various embodiments, playing preferences may be received via a Web site. In various embodiments, playing preferences may be received over the phone, orally in person, or in any other manner.

At step 1716, content may be scheduled. Content may be scheduled so as to satisfy playing preferences received at step 1712. For example, if a marketer has requested that its advertisement be played once an hour during weekday afternoons on displays inside malls, then the advertisement may be scheduled to play following these guidelines.

At step 1720, content may be caused to play. For example, server 104 may transmit the content and/or instructions to play the content to one or more displays in digital signage system 100. The server may also transmit playing schedules for the content (and for any other content) to one or more displays in system 100.

At step 1724, the circumstances under which content played may be determined. Note that, in various embodiments, content may not have played when it was scheduled to be played. For example, an equipment failure, an electrical failure, or a network failure may have prevented content from being played according to its original schedule. Thus, in various embodiments, an indication may be received, where the indication is of whether or not content played, whether content played on schedule, or other circumstances under which content was played. Indications may be received by server 104, for example. Indications may be provided, for example, by one or more displays, one or more media players, one or more computers, or one of more other devices (e.g., one or more other devices within digital signage system 100).

In various embodiments, circumstances under which content was played may include the viewers that were available to perceive the content. In various embodiments, an indication of the number of people who viewed an item of content may be received. In various embodiments, an indication of average length of time people gazed at an item of content may be received. In various embodiments, an indication of a demographic of a viewer may be received. For example, the server 104 may receive an indication that a man in his twenties was watching a particular item of content while it was playing. In various embodiments, various other information about viewers may be received.

In some embodiments, a viewer may have the opportunity to interact with content. For example, a viewer may answer a survey question that was asked. Thus, an indication of a viewer's answer to a survey or of any other action taken by a viewer may be received.

In some embodiments, information about other circumstances present when content was played may be received. Such circumstances may include weather conditions, the ambient temperature, ambient noise levels, smog levels, the existence of nearby events (e.g., the existence of nearby sporting events), or any other circumstances. In various embodiments, information about circumstances may allow an operator of the signage system or a marketer or another party to better analyze the effectiveness of content. For example, if an advertisement for ice cream is played with no apparent effect on sales, the outcome may be explainable by the fact that it was below freezing outside at the time the ad was played.

At step 1728, a reconciliation report may be generated. The report may be similar to report 1600, according to some embodiments. The report may show how often and under what circumstances content was played. The report may show how much a marketer, content provider, or other user of digital signage system 100 owes.

In some embodiments, money may be owed to a content provider or other party. For example, the operator of digital signage system 100 may pay content providers for interesting content that will draw the attention of viewer. Thus, in various embodiments, a reconciliation report may show amounts owed to a content provider or to another party.

At step 1732, a content provider may be billed. The content provider may be an advertiser, for example. In some embodiments, the reconciliation report may serve as a bill or invoice. The reconciliation report may be sent to the content provider. As will be appreciated, the content provider may be billed in other ways. The content provider may be notified about an amount owed via email, phone, or via any other means.

At step 1736, payment may be received from the content provider. In various embodiments, the content provider may be charged automatically (e.g., a credit card number of the content provider may be kept on file and billed automatically when advertisements of the content provider have been played).

It will be appreciated that the steps 1700 illustrated in FIG. 17 represent some embodiments. In various embodiments, additional steps may be added, or some steps may be omitted. In various embodiments, steps may be performed in a different order.

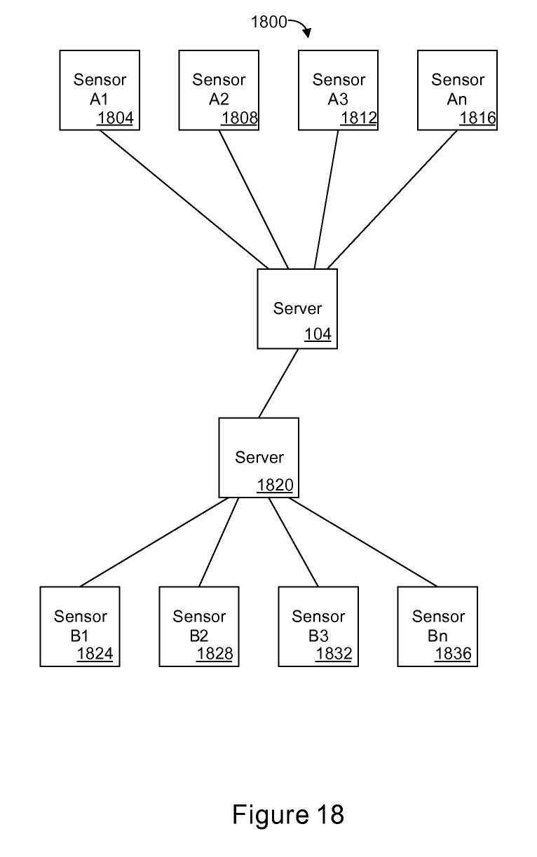

FIG. 18 shows a network of sensors, according to some embodiments. Sensors may include cameras, microphones, infrared sensors, pressure sensors (e.g., sensors in sidewalks), touch sensors, RFID sensors, antenna, vibrations sensors, radar detectors, smell or chemical sensors, or any other sensors.

In various embodiments, sensors may serve various functions or uses for or within digital signage system 100. In various embodiments, sensors may measure human traffic. Sensors may thus allow advertisers or other content providers to measure the size of the potential audience for their ads. In various embodiments, sensors may measure gaze or other indicators of human attention. This may also allow advertisers to gauge the impact their ad has made. For example, ads that have attracted longer gazes may be considered to have had greater impact. In some embodiments, sensors may allow a targeting of ads or other content. For example, in some embodiments, a digital sign may physically pivot or rotate to face a person. In some embodiments, sensors may be used (e.g., in combination with computer algorithms) to determine demographic or other characteristics of people. Such characteristics may be used to target ads or other content. In some embodiments, sensors may be used for interactivity. For example, a display within system 100 may function as a touch screen that may allow people to answer questions, provide feedback, ask questions, or otherwise interact.

In various embodiments, sensors may be built into displays of the digital signage system 100. In some embodiments, sensors may be physically connected to displays. In some embodiments, sensors may be in electronic communication with displays. In some embodiments, a sensor may be completely separate from any display. For example, a sensor may be located ten feet away from a display. The sensor may detect the presence of a person and thereby cause the display to power on or to otherwise seek to get the attention of the person.

As shown in the network 1800, one or more sensors (e.g., sensors 1804, 1808, 1812, 1816) may be in communication with server 104. Sensors may report various information to the server 104. The server may then use such information to issue commands to displays, to generate reconciliation reports, or to perform any other function. In some embodiments, one or more sensors (e.g., sensors 1824, 1828, 1832, 1836) may be in communication with another server 1820. Server 1820 may, in turn, be in communication with server 104. It will be appreciated that various other network architectures are possible. In some embodiments, sensors may be in communication with displays, media players, or computers of digital signage system 100, rather than with server 104.

### Rules

In some embodiments, a schedule for the playing or presenting of content need not be determined or completely determined in advance. In some embodiments, a given item of content may be played based on current circumstances or triggering conditions rather than based on a predetermined schedule. For example, a certain item of content may be played when a person of a target demographic is looking at a display. As another example, an item of content advertising sun tan oil may be played only when the weather is currently sunny.

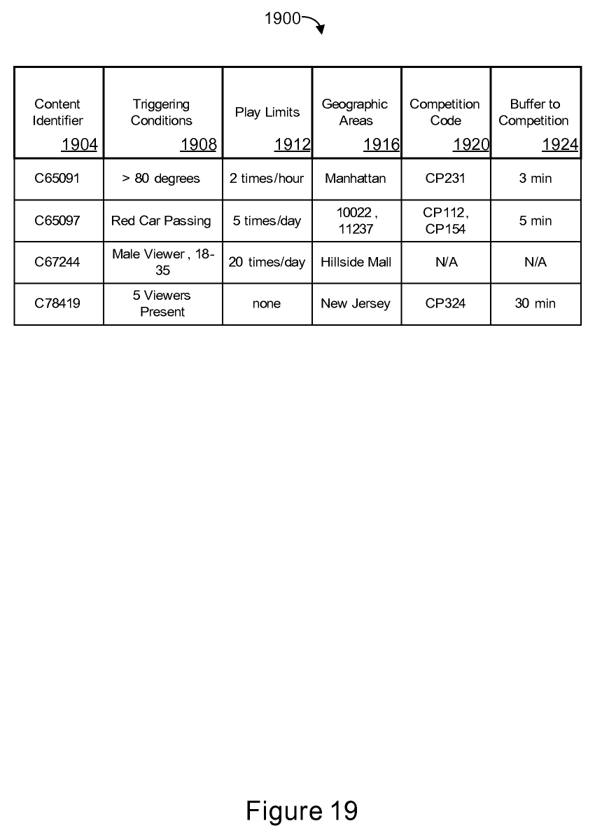

FIG. 19 shows a rules database 1900, according to some embodiments. The database may include one or more rules that determine when a given item of content will play. Field 1904 may include content identifiers. Field 1908 may include triggering conditions. Such conditions may include conditions that, upon their occurrence, will cause the corresponding content to be played. For example, when the weather exceeds 80 degrees, content C65091 may be played. Field 1912 may include play limits. Play limits may put boundaries on the number of times that a given item of content may be played. For example, play limits may indicate that a given item of content is to be played no more than twice every hour. Otherwise, for example, the item of content might play continuously so long as its triggering condition was met. Field 1916 may include geographic areas. Geographic areas may represent areas where the content may be played. In some embodiments, specific geographic areas may be indicated where a given item of content is not to be played.

Field 1920 may include, for a given item of content, one or more competition codes. Competition codes may represent certain industries (e.g., restaurants; e.g., travel), certain product categories (e.g., shoes; e.g., cars; e.g., soft drinks), certain service categories (e.g., medical practices; e.g., barber shops), or any other categorization. A competition code may indicate a category in which competitors of the provider of the content fall. For example, a soft drink manufacturer may have provided a given item of content which is an ad for their soft drink. The competition code for the item of content may therefore represent soft drinks. The provider may desire that the item of content not be played within a given amount of time of content from another soft drink manufacturer. In various embodiments, the competition code may represent a category in which a given item of content falls. In various embodiments, the competition code may represent a category in which a provider of a given item of content falls. In various embodiments, a competition code may represent a code such that a provider of content does not wish for its item of content to be played within a certain period of time of another item of content corresponding to the competition code. Field 1924 may include a buffer time period. This may represent the amount of time that must elapse between the playing of a first item of content, and the playing of a second item of content corresponding to the same competition code.

As will be appreciated, many other rules could be used to determine when a given item of content will be played. Database 1900 is representative of but some examples of some rules that may be used, according to various embodiments. As will be appreciated, in various embodiments, rules could be used for determining when entire playlists will play.

### Interaction Between Two Regions

In some embodiments, content played in a first region of a display may correlate to content played in a second region of the display. For example, a first region of a display may show news. A second region of the display may be keyed to the first, so that, for example, advertisements in the second region will be triggered by certain news events. For example, when the news turns to weather, an ad for home gutters may be triggered to play. When the news turns to Halloween, an ad for costumes may be triggered. In this way, content played in a second region may be more relevant to content played in a first region.

In various embodiments, content may be associated with meta-tags, descriptions, or other associated information. For example, a given news segment may have a meta-tag of “weather, rain”. Another news segment may have a meta-tag of “entertainment”. In some embodiments, a meta-tag may include all or a portion of a transcript of content. In various embodiments, a submitter of content may supply meta-tags. In some embodiments, meta-tags may be determined by a human reviewer or evaluator. In some embodiments, a computer algorithm may use character recognition, speech recognition, image recognition, or some other process for extracting information about content and producing a meta-tag from such information.

In some embodiments, content may include closed captioning. The closed captioning may include a text transcript of an audio portion of content. The closed captioning may be broadcast along with the content. For example, a text transcript of a talk show may be broadcast and displayed in conjunction with the visual and audio portion of the talk show. A viewer of the broadcast might see the visual and hear the audio portions through his television or other display, but may also be able to see the text transcript or closed captioning associated with the broadcast.

In some embodiments, a first region may be an independent, or driving region. Content shown in the first region may not be triggered by content in other regions, but may play according to a preset schedule or according to some other rules. On the other hand, a second region may be a dependent, or following region. Some content that is to play in the second region may be dependent on content that has been shown, that is showing, or that will be shown in the first region. For example, a second item of content may play in the second region only when a first item of content is to play in the first region. It will be appreciated that not all content played in the second region need necessarily be triggered by other content. For example, some content that is to be played in the second region may be prescheduled, while other content that is to be played in the second region may be triggered by content that is played in the first region.

In various embodiments, rules used to schedule content in the second region may utilize meta-data for content that is played in the first region. For example, a scheduling algorithm may search for certain key words in the meta-tags of content that is to be played in the first region. If the algorithm finds one of the key words, then a particular item of content may be scheduled to play in the second region at a particular temporal relationship (e.g., before; e.g., during; e.g., after; e.g., 3 seconds after; e.g., starting two seconds after the beginning; etc.) to the content with the given meta-tags that is to be played in the first region.

As an example, a provider of an ad for pet food may wish for the ad to be featured when a concurrently running news segment mentions such words as “cat”, “kitten”, “kitty”, “pet”, or “purr”. Thus, a scheduling algorithm may search the meta-data of content scheduled to be played in a first region of a display. If the scheduling algorithm finds an item of content (e.g., a news segment) which has “kitten” as a meta-tag (e.g., the news segment is about a kitten stuck up a tree), then the ad for pet food may be schedule to play in the second region concurrently with the identified item of content scheduled for the first region.

In some embodiments, a closed captioning feed, or other transcript of the content played in a first region may be used to trigger, select, or otherwise schedule content that will play in a second region. The closed captioning may be searched for keywords, key phrases, for particular names, or for any other combination of characters, or any search criteria. Upon occurrence of words, names, phrases, etc., that match search criteria, certain content may be triggered. The content may be triggered to play in the second region, or even to play in the first region. For example, if the word “doctor” appears in closed captioning, then a second region may play an advertisement for a local doctor.

In some embodiments, content that is to play in a given region may be triggered by other content that is to play in the same region. For example, when a first item of content plays in the second region, meta-tags associated with the first item of content may trigger the playing of a second item of content in the second region. The second item of content may play immediately after the first item of content.

In various embodiments, multiple criteria may be used to trigger the display or playing of content. For example, a closed captioning feed in a first region may include the word salon. This may trigger the playing of a salon advertisement in a second region. However, the particular salon advertisement played (e.g., out of many possible salon advertisements) may be chosen based on the location of the display. For instance, an advertisement may be played for a salon that is within a 2-block radius of the display.

### Make Adjustments Based on the Direction of a Viewer's Gaze

In some embodiments, two or more items of content may be featured on a particular display at the same time. In some embodiments, the two or more items of content may compete for the attention of one or more viewers. For example, there may be two different advertisements displayed on a given display at the same time. One ad may be in a first region of the display (e.g., on the left half) and another ad may be in a second region of the display (e.g., on the right half).

In some embodiments, digital signage system 100 and/or sensor network 1800 may include a camera. The camera may capture one or more images of a viewer who is looking at a display. The image(s) may be used to determine where on the display the viewer is looking. For example, the image(s) may be used to determine that the viewer is gazing towards the upper right hand corner of the display, or towards the middle of the display. In various embodiments, the image(s) may be used to determine a particular region of the display towards which a viewer is gazing. For example, it may be determined that the viewer is looking towards a second of three regions on the display. In various embodiments, the images may be used to determine a particular item of content the viewer is watching. The particular item of content may be displayed in a particular region and may therefore correspond to a particular region.

Captured images may be used to determine a direction of gaze in various ways. In some embodiments, a viewer's position within a captured image may be determined. The viewer's angle with respect to the capturing camera (or other image capturing device) may then be determined. The user's distance from the capturing camera may also be determined, such as from the viewer's apparent size within the image, or such as from the viewer's relationship within the image to other objects of a known distance or position. For example, if the image shows the viewer to be standing on a particular tile on the floor, and if the distance of the tile to the capturing camera is known, then the viewer's distance form the camera may be determined. In some embodiments, the angle of the focus of the viewer's pupils may be determined from an image of the viewer's face. For example, the shape of the pupils within the image may be determined. A round shape may indicate that the pupils are looking straight on into the capturing device, while a more oval shape may indicate more of a sideways vantage point to the pupils, which may indicate that the pupils are gazing in a direction away from the capturing device. The image may also show portions of the viewer's eye to either side of the viewer's pupil. If equal portions of the viewer's eye are visible on either side of the pupil, then it may be inferred that the viewer is looking directly at the capturing device. However, if more of the viewer's eye is visible on one side of the pupil then the other, then it may be inferred that the viewer is gazing in a direction away from the capturing device. It will be appreciated that there may be various other ways of determining the direction of a viewer's gaze.

In various embodiments, once the distance of the viewer from a camera is known, once the direction of the viewer's gaze with respect to the camera is known, and once the spatial relationship of the camera with respect to the display is known, then the part of the display (e.g., the region of the display) at which the viewer is gazing may be determined with trigonometric algorithms, as will be appreciated.

As will be appreciated, various other means of determining the direction of a viewer's gaze may be determined. For example, infrared light may be reflected off the viewer's eyes, and the angle of reflection (or the occurrence of any reflection) may be used to determine the direction of the viewer's gaze.

Methods of detecting the direction of a viewer's gaze are described in the following patents, all of which are incorporated by reference herein for all purposes:
U.S. Pat. No. 7,346,192, “Image processing system and driving support system” to Yuasa, et al.
U.S. Pat. No. 7,266,225, “Face direction estimation using a single gray-level image” to Mariani, et al.
U.S. Pat. No. 6,456,262, “Microdisplay with eye gaze detection” to Bell.

In various embodiments, the direction of a viewer's gaze may be correlated with an item of content currently playing where the viewer is looking. For example, if it is determined that the viewer is looking at region 1 of a display, it may be determined what item of content is currently being played in region 1 of the display.

In various embodiments, the provider of an item of content (e.g., an advertiser) may be informed that its content was looked at or gazed at by a viewer. The advertiser may thereby measure the impact or effectiveness of its content. In some embodiments, the advertiser may be charged based on the number of viewers who gazed at its content. For example, the advertiser may be charged a fixed amount per person who gazed at the content.

In some embodiments, when it is determined that a viewer is gazing at a particular region or at a particular item of content, the perceptibility of the region and/or of the item of the content may be altered (e.g., the perceptibility may be enhanced). In some embodiments, the region at which a viewer is gazing may be enlarged. The content within the region may be correspondingly enlarged to occupy the newly expanded region. Thereby, for example, the viewer may have a better opportunity to perceive content in which he has shown interest. In some embodiments, other content currently being displayed (e.g., within other regions of the display), may be made smaller.

In some embodiments, when it is determined that a viewer is gazing at a particular item of content, a volume of audio associated with the content may be increased. For example, if the volume had been completely off, the volume may be turned on. As another example, if the volume was on, the volume may be increased. In some embodiments, the volume for other content currently being played (e.g., for content that the viewer is not currently gazing at) may be reduced or eliminated.

In some embodiments, when it is determined that a viewer is gazing at a particular item of content, audio associated with that content may be broadcast to the viewer using directional sound. In this way, for example, the viewer may have the opportunity to hear audio associated with the content, while a nearby person may remain undisturbed by the audio. Audio associated with content may include a soundtrack, spoken words by actors featured in the content, spoken words by a narrator, sounds from the scene the content is depicting (e.g., sounds of lions growling if the content depicts a safari), and so on. In various embodiments, two different viewers may each view the same display. The two viewers may gaze at different regions on the display. Directional sound containing audio from a first of the two regions may then be beamed to the first viewer, and directional sound containing audio from a second of the two regions may be beamed to the second viewer. The two viewers, though they view the same screen, may thereby listen to distinct audio tracks, in some embodiments.

In some embodiments, when it is determined that a viewer is gazing at a particular item of content, the brightness of the content may be altered (e.g., increased), the contrast of the content may be altered (e.g., increased), the color scheme of the content may be altered, or any other alteration to the content may be put into effect. Alterations to the content may enhance the perceptibility of the content, in various embodiments.

In some embodiments, when it is determined that a viewer is gazing at a particular item of content, the rate of play or the rate of progress of the content may be altered. For example, an item of content may be put into slow motion. As another example, an image that had been scheduled to be displayed for only 5 seconds may instead be displayed for seconds. In some embodiments, the progression of a ticker may be slowed. For example, rather than scrolling off the screen in 4 seconds, a given piece of information may remain in the screen for 8 seconds before scrolling off. Alterations to the rate of play or to the progress of content may give a viewer greater opportunity to perceive, admire, understand, or otherwise take in content.

In some embodiments, when it is determined that a viewer is gazing at a particular item of content, the content may be restarted from the beginning. For example, a viewer may begin looking at an item of content halfway through the presentation of the content (e.g., halfway through a video, if the content is a video). If the content is restarted, the viewer may have the opportunity to view the content in its entirety. In some embodiments, an item of content may be repeated one or more times what it is determined that a viewer is gazing at the item of content. The viewer may thereby be given more opportunities to perceive and/or appreciate the item of content.

### Directional Sound

Various embodiments contemplate sound or audio that may be focused in a particular direction. Various embodiments contemplate sound or audio that may be projected to a particular area or location with minimal perceptibility in other locations (e.g., in nearby locations). Various embodiments contemplate sound or audio that can be projected or focused in a tight beam, and which may thereby be heard by some people, but not by others (e.g., by nearby people). Such sound or audio may be referred to herein as “directional sound”, “directional audio”, “hyper-directional sound”, “sound beams”, and the like.

Some methods for producing directional sound are described in the following patents, all of which are incorporated by reference herein for all purposes:
U.S. Pat. No. 7,292,502 “Systems and methods for producing a sound pressure field” to Barger
U.S. Pat. No. 7,146,011 “Steering of directional sound beams” to Yang, et al.
   Pricing Based on Content Viewer Ratings from Other Media

In some embodiments, a first item of content featured on a display of system 100 may include content also featured on broadcast TV, cable, satellite, or the Internet. The first item of content may be a sports game, for example. When shown on TV, cable, satellite, or internet, the same item of content may receive a rating based on the number of viewers. The rating may be a Nielsen rating, for example. The number of viewers may be readily measurable on TV, cable, satellite, or internet, for example. In some embodiments, when the first item of content is shown on system 100, a provider of a second item of content (e.g., an advertisement) may be charged a price based on the number of viewers of the first item of content as measured on television, cable, and/or the Internet. In some embodiments, the number of viewers of a given item of content as measured on television, cable, satellite, the Internet, or on some other medium, may serve as a proxy for the number of viewers of the item of content on a digital signage system. Advertising rates or other rates may be set accordingly. In some embodiments, the showing of a second item of content may be triggered by the viewership ratings of a first item of content that is being shown on the digital signage system. For example, if a football game is being shown on TV and on digital signage system 100, and the ratings exceed a certain level on TV, then a particular ad may be shown on digital signage system 100 in conjunction with the football game.

### Timeline and Scheduling

In some embodiments, a calendar view shows days for which content is scheduled to play on system 100, or on a particular display on system 100. In some embodiments, the calendar view may show what days are fully scheduled (e.g., all available times slots and/or space on the a screen is filled), partially scheduled, and what days are not scheduled at all. In some embodiments, a calendar may show the same for shorter lengths of time. For example, a calendar may present a view of a single day and may show which hours are fully scheduled, which hours are partially scheduled, and which hours are not scheduled at all.

In some embodiments, an owner, operator, or other user of digital signage system 100 may wish to schedule content for play on one or more displays of system 100. A user create a playlist or otherwise designate a set of content. The user may indicate a start time, an end time, and/or a total playing time of the playlist.

In some embodiments, a graphical user interface may show a representation of a calendar or a timeline. Superimposed on the calendar or timeline may be a bar or other indicator showing the duration for which the playlist is scheduled to play. If no playlist has been scheduled for a particular period of time, then the calendar may have no bar or indicator corresponding to that period of time.

In some embodiments, the calendar or timeline may visually indicate to a user what days and/or what times have content scheduled. For example, on a view of a monthly calendar, days shown in a first color may represent days when all available time slots have been filled with scheduled content. Days shown in yellow may represent days when some, but not all available time slots have been filled with scheduled content. Days shown in green may represent days when no available time slots have been filled with content. In various embodiments, other colors, patterns, or other indicators may represent degrees to which available time slots and/or available space on displays has been filled.

For example, a day on a calendar may be shown in a first shade of yellow if more than half the time slots have been filled with scheduled content, but may be shown in a second shade of yellow if less than half the time slots have been filled.

In some embodiments, a timeline may show a bar that stretches over time slots when content has been scheduled. If all available time slots within a given time period have been filled, then the bar may stretch continuously to span the entire time period. However, if content is not scheduled for certain times, then there may be breaks or gaps in the bar at those times.

In some embodiments, two or more parallel bars shown on a timeline may represent different regions of a screen. For example, if a first region has had all its time slots scheduled for a given period of time, then the bar representing the first region may be continuous over the time period. However, if a second region has had only some of its time slots scheduled for the given period, then the bar representing the second region may be broken over the same period. As will be appreciated, there may be any number of parallel bars, with each bar representing a different region.

In some embodiments, bars may be shown for more than one display. For example, three displays may be represented on a timeline using three parallel bars. As will be appreciated, any number of displays may be represented in this fashion with a corresponding number of parallel bars.

Though bars have been described with respect to some embodiments, it will be appreciated that different representations may be used relating to the degree to which time slots or space on displays has been filled. For example, a dial may have an indicator varying from 0% to 100% to show the percentage of time slots of a given time period (e.g., of a given hour; e.g., of a given day) that have been filled.

In some embodiments, various statistics may be shown on a calendar or timeline view. Such statistics may be shown in conjunction with indicators (e.g., bars) about which time slots have been filled with scheduled content. Statistics shown may include: (a) foot traffic (e.g., anticipated foot traffic near a given display at a given time of day); (b) predicted weather; (c) scheduled events (e.g., sports games; e.g., conventions; e.g., sales at a nearby retail store); and/or various other data.

### Two Regions Play Content for the Same Period of Time

In some embodiments, a user may create a layout with two regions. The user may create a first playlist that is formed from one or more items of content. The user may create a second playlist that is formed from one or more items of content. The user may designate that the first playlist will play in the first region and the second playlist will play in the second region. For example, the user may drag a representation of the first playlist (e.g., an icon) into the first region and a representation of the second playlist into the second region. In some embodiments, the second playlist will have a shorter total playing time than the first playlist. Thus, for example, if both playlists where to begin playing at the same time, the second region would potentially be left blank after the second playlist had finished playing, and while the first playlist was still playing.

In various embodiments, if two regions are matched to (or otherwise correspond to) playlists of different total run times, then a user may be alerted as to the unequal play times. For example, the user's computer screen may print a warning that the region with the shorter playlist may be left blank for some period of time. In some embodiments, a representation of the second region may be shown in a different color or pattern. The user may be alerted in various other ways, such as through a tone, a flashing background in a representation of a region (e.g., of the second region), or in some other fashion.

In some embodiments, steps may be taken to equalize the playing time of the content to be played in each of two regions, or to otherwise fill empty time slots. In some embodiments, a portion of the content from the second playlist may be repeated after the second playlist has completed one run through. For example, the first two items of content in the second playlist may be scheduled for play in the second region once the second playlist has finished playing. Thus, the first two items of content in the second playlist may be played twice, whereas all other items of content forming the second playlist may be played once. In some embodiments, other items of content from the second playlist may be repeated, not necessarily the first or earliest items of content. In some embodiments, once the second playlist finishes, the second playlist may be started over from the beginning and played until the first playlist has finished playing. In some embodiments, e.g., if the second playlist is much shorter than the first playlist, the second playlist may be repeated multiple times while the first playlist plays.

In some embodiments, default content may be scheduled after the conclusion of the second playlist. Default content may include content that has been supplied by an advertiser or other content provider who is receiving preferential rates in view of filling excess or waste time that no one else has purchased. Default content may include content that has been supplied by the signage system owner or operator, e.g., to promote the system.

In some embodiments, other content may be scheduled to play after the second playlist has finished playing. For example, content not already used to form the second playlist may be scheduled to play after the second playlist has finished playing in the second region. In some embodiments, the user may be prompted to select additional content to schedule after the second playlist. In some embodiments, additional content may be supplied or inserted automatically.

In some embodiments, content in the second playlist may be extended or its content altered so that the second playlist more closely matches the first playlist in total playing time (e.g., so the second playlist becomes equal in playing time to the first playlist). In some embodiments, the rates of play of one or more items of content forming the second playlist may be reduced. For example, a video may be put into slow motion, or into slightly slower motion than the rate at which it was originally intended to play. In some embodiments, a still frame or image that had been scheduled to show for a first amount of time (e.g., for five seconds) may be rescheduled to show for a second amount of time (e.g., for 10 seconds). In this way, the duration of the second playlist may be extended.

In some embodiments, the first playlist may be shortened or otherwise altered so that the first playlist more closely matches the second in total playing time. In some embodiments, still images may be played for a shorter period of time. In some embodiments, the rates of play of certain content within the first playlist may be sped up (e.g., certain frames may be omitted).

In some embodiments, a timeline or calendar view may distinguish between content that has been scheduled by a user, and content that has been inserted into a schedule (e.g., automatically inserted into a schedule). The content that has been inserted into the schedule may have been inserted so that the schedules for the first and second regions matched. As an example, content that has been scheduled by a user may be represented by a first colored bar, and content that has been automatically filled in may be represented by a second colored bar.

Statistics about Current System Operations

In various embodiments, an administrator, an operator, an owner, or other user of digital signage system 100 may view various statistics about the system 100. In various embodiments, the user may view information about the status of one or more displays or other devices within system 100. A user may view an indication of whether a display is working or not. A user may view an indication of the amount of bandwidth to or from a display. A user may view various other statistics or status indicators. Statistics may pertain to: (a) network settings (e.g., mac address, IP, bandwidth and throughput); (b) system status (e.g., CPU and memory usage, load average, usage as a percentage of availability of some resource, system heat); (c) disk (e.g., free space, used space, total space, smart poll/status); (d) screen (e.g., brightness, hours in operation, re-sync, poll (DNC), resolution); (e) play status (e.g., screenshot, current media file, current playlist with progress, ID screen); (f) time (e.g., NTP server, what time is it, time zone, NTP status); (g) command and control (e.g., reboot, shut-down, reset to factory); (h) notes. The user may view information about the system via a computer or other device (e.g., computer 152), including a device connected to server 104.

1. Buying and Selling of Space on the Digital Signage System. According to some embodiments, opportunities to have content featured on digital signage system 100, or on any other digital signage system, or on any other system, may be bought and sold. The opportunity to have content featured may be referred to herein as “space”, “advertising space”, “content space”, “time slot”, “content slot”, or the like. Thus, for example, “space” on a digital signage system may be bought and sold. A seller may include an owner or operator of system 100. A buyer may include an advertiser that wishes for its content to be displayed on system 100. A buyer may include any other content provider as well, including a government agency, a non-profit organization, an individual seeking to wish “happy birthday” to another, or any other person. In various embodiments, once bought, opportunities to have content featured may be resold. Thus, for example, a buyer of content space may in turn resell the same content space to another buyer. It is thus possible that a seller of content space does not own the physical displays or the physical signage system where advertising or other content will eventually be featured. The seller may simply be a speculator, for example, who seeks to earn profits by buying advertising space at a low price and selling it at a higher price.
1.1. NATURE OF THE SPACE. The nature of content space that is bought and sold may vary along one or more dimensions. In various embodiments, content space may be denominated using various units of measurement.
   1.1.1. TIME. Content space may be denominated in units of time. Content space may be denominated in terms of seconds, minutes, hours, etc. For example, 10 hours worth of content space may be bought or sold. In various embodiments, a time denomination may represent a total amount of time during which content will be featured. For example, an advertiser who buys 10 hours worth of content space may have its advertisement featured for a total of 10 hours of play time. In some embodiments, a time denomination may represent an amount of time per display, per geographic region, per play cycle (e.g., per hour), and/or per some other unit. For example, an advertiser may purchase 5 minutes of content space per screen across a digital signage system of 100 screens. This may mean that the advertiser's content will actually be played for a total of 500 minutes (e.g., for 5 minutes on each of the 100 screens). As another example, an advertiser may purchase 30 seconds in a “cycle” of content that is 1 hour long. Thus, the advertiser's advertisement may play for 30 seconds every hour on a particular display.
   1.1.2. DISPLAYS. Content space may be denominated in terms of a number of displays, a number of screens, or a number other devices for presenting content. For example, an advertiser may purchase space on 1000 displays.
      1.1.2.1. FRACTIONS OF A SCREEN. In some embodiments, content space may be denominated in terms of fractions of a screen. Note that, in various embodiments, a display may be divided into two or more parts, and separate items of content may be shown on each part. Thus, in various embodiments, an advertiser (or other party) may purchase half screens, quarter screens, eighth screens, or any other fraction of a screen. For example, an advertiser may purchase 30 seconds on 2000 quarter screens. This may allow the advertiser an opportunity to present its ad for a total of 30 seconds on each of 2000 displays, where the ad would occupy a quarter of the screen area on each display when presented. In various embodiments, content space may be denominated in pixels, square inches, square centimeters, in terms of diagonal inches (e.g., in terms of the length of the diagonal across the screen area where the ad would be presented), or in terms of any other unit.
   1.1.3. VENUES. In various embodiments, content space may be denominated in terms of venues. For example, an advertiser may purchase ad space for 50 venues. The advertiser may thereby obtain the right to show ads for a certain amount of time (e.g., 5 minutes total), in each of 50 venues. In various embodiments, a given venue may include a restaurant, retail store, mall, a particular geographic location, or any other place, area, or location. A venue may include one or more displays.
   1.1.4. SIMULTANEOUS DENOMINATION. In various embodiments, content space may be simultaneously denominated in terms of several units. For example, content space may be denominated in terms of time and number of screens. For example, an advertiser may purchase 5 minutes per screen on each of 200 screens.
1.2. THE FORUM. In various embodiments, buyers and sellers of content space may come together in a market, exchange, or other area for transacting and/or for otherwise bringing together buyers and sellers. The forum may by a physical location, such as a building, a trading floor, an exchange pit, or any other physical location. The location may also be a virtual or electronic location. The market may consist of one or more interconnected computers, servers, and/or other devices that allow buyers, sellers, and/or intermediaries to communicate with one another and to transact business. An exchange or other forum may be owned and/or operated by a distinct entity, such as a business entity, a government entity, a non-profit entity, or any other entity.
1.3. APPROVAL PROCESS FOR CONTENT. In various embodiments, displays of digital signage system 100, or of any other system, may be located in a public venue, a retail venue, or a venue otherwise exposed to various people. Owners, operators, or other stakeholders in the venue may have interest in maintaining standards of decency, propriety, morality, etc., in the content that is presented within the venue. For example, an owner of a retail store that hosts displays may not wish for the displays to present vulgar content, as such content may offend customers. According to various embodiments, there may be a process for ensuring that content shown on a digital signage network conforms to one or more standards.
   1.3.1. STANDARDS. In various embodiments, one or more standards are set forth for content. Standards may be set by a seller of content space, by a digital signage network owner or operator, by a host of a one or more displays on a digital signage network (e.g., by an owner of a store that hosts a display), by a standards body, by an exchange or other forum for buying and selling content space, by a government, by a governing body, or by any other entity. Standards may include an indication of forbidden words; an indication of forbidden topics (e.g., politics); an indication of forbidden products; an indication of dress standards (e.g., characters featured in content must dress or not dress in certain ways); and/or an indication of any other standards.
      1.3.1.1. SETS OF STANDARDS. In various embodiments, there may exist different sets of standards. Two or more sets of standards may vary in the degree to which they permit or proscribe content of a certain nature. For example, a first set of standards may forbid all vulgar language (e.g., all words from a certain list that is considered to include vulgar words), and a second set of standards may permit some words (but not necessarily all words) that are considered vulgar. Two different sets of standards may be given different names or short hands, such as “G” or “PG” or the like. Standards may also vary along different dimensions. For example, a first set of standards may describe the standards content must adhere to in order to be politically neutral. A second set of standards may describe the standards content must adhere to so as to be suitable for viewing by a general audience (e.g., by children). In various embodiments, a given item of content may be required to adhere one set of standards, to two sets of standards, or to any number of sets of standards, all at the same time.
   1.3.2. APPROVAL PROCESS. In various embodiments, content that is submitted to be played on a digital signage system goes through an approval process before it is played or otherwise featured. The approval process may be used to verify or ensure that the content meets one or more sets of standards.
      1.3.2.1. WHO APPROVES.
         1.3.2.1.1. EXCHANGE. In various embodiments, an exchange or other market for buyers and sellers may approve content. The exchange may have a designated committee, body, or other group that deals with the approval of content.
         1.3.2.1.2. DIGITAL SIGNAGE NETWORK HOST. In various embodiments, a host of a digital signage system, or of part of a digital signage system, or of one or more displays of a digital signage system, may approve content. The host may include a business or other location, which may stand to suffer a damaged reputation if inappropriate content is presented within its establishment. Thus, the host may have an interest in approving content.
         1.3.2.1.3. DIGITAL SIGNAGE NETWORK OPERATOR. In various embodiments, the owner, operator, and/or manager of a digital signage system may approve content submitted to be played on the digital signage system. The owner may risk damaged reputation if inappropriate content is shown on its network.
         1.3.2.1.4. THIRD PARTY. In various embodiments, a third party may approve content to be shown on a digital signage system. The third party may include a separate business entity, a standards body, or any other entity. The third party may be paid to approve content for display.
      1.3.2.2. SUBMISSION OF A TRANSCRIPT. In various embodiments, a provider of content or any other entity, may be required to submit a written transcript of the content. The written transcript may aid with the review process. Using the written transcript, a reviewer may search for prohibited words or phrases. A reviewer may search for prohibited topics, such as politics, religion, or any other issue. A transcript may include, in some embodiments, text or other verbiage that is to be shown visually in conjunction with content. A transcript may include a transcript of words or other utterances presented audibly as well.
      1.3.2.3. STANDARD CONTRACT. In various embodiments, a supplier of an item of content may be required to sign a contract. The contract may enumerate standards that the submitted content must meet. The contract may enumerate penalties that the supplier would suffer if the supplied content is found not to meet one or more standards or sets of standards. The contract may enumerate an adjudication, arbitration, or other process by which it will be determined whether submitted content meets one or more standards. Penalties may include fines, bans from the ability to submit further content, and so on.
      1.3.2.4. REVIEW PROCESS.
         1.3.2.4.1. ALGORITHMS. In various embodiments, algorithms (e.g., computer algorithms) may be used to review content that has been submitted. Computer algorithms may scan transcripts of submitted content for key words, phrases, or topics. The algorithm may create an alert if any prohibited works, phrases, or topics are found. Algorithms may include artificial intelligence that is capable of recognizing certain topics, certain tones, or other themes within content. In various embodiments, voice recognition or voice transcription algorithms may be used to convert audio within content to text or to other symbolic form. The text or other symbols may then be searched for particular words, phrases, topics, etc. In various embodiments, image recognition algorithms may be used to recognize potentially inappropriate images, such as images of violence, crudeness, or any other images relevant to certain standards. In various embodiments algorithms may flag an item of content for later review by humans. In some embodiments, algorithms may outright prevent certain content from being featured on digital signage system 100 due to failure to comply with one or more standards or sets of standards.
         1.3.2.4.2. REVIEWERS. In various embodiments, one or more human reviewers may review content that has been submitted to be played or featured on a digital signage system. Human reviewers may search for words, images, text, or other markers that may signify an item of content does not meet one or more standards or sets of standards. In various embodiments, human reviewers may go through training courses or tutorials for reviewing content. Different training courses may apply to different sets of standards. A reviewer may become certified in a particular set of standards, or in more than one set of standards. In various embodiments, an item of content may be shown to multiple reviewers. A certain fraction of reviewers may be required to approve of the content before it will be actually shown on a particular digital signage system (e.g., two thirds of reviewers must approve; e.g., 100% of reviewers must approve).
         1.3.2.4.2.1. VERIFYING THE REVIEWERS. In various embodiments, reviewers may be tested through the presentation to them of content that has already been reviewed by others. For example, an item of content that has already been found not to comply with certain standards may be presented to a reviewer. If the reviewer rates the content as something that does comply with the standards, then it may be inferred that the reviewer is not competently reviewing content. Content that is presented to reviewers, and which has not been reviewed before, may be periodically interspersed with content that has been reviewed before. The reviewer may never know which content has and which content has not been reviewed before. In this way, the accuracy of the reviewers work may be verified.
   1.3.3. TRUSTED PARTY. In some embodiments, a party who submits content (e.g., an advertiser) may become trusted or otherwise accepted as a party whose content can be relied upon to conform to one or more standards. Content submitted by such a party may receive less or no scrutiny. Rather, the content from the party may be trusted to conform to standards. This may save the digital signage network owner, or other parties, from having to review content.
      1.3.3.1. REGISTRATION PROCESS FOR THE TRUSTED PARTY. An advertiser or other party who becomes a trusted party may go through a process for doing so. A party may become trusted after any one or more of: (a) submitting a predetermined minimum number of content items; (b) submitting content items and achieving a certain minimum percent compliance with a set of standards (e.g., a party must achieve 100% compliance with 250 submitted content items); (c) taking a training or certification course; (d) implementing a training or certification course; (e) signing or otherwise entering into a contract; (f) agreeing to pay a penalty if the party is found to have submitted content which did not conform to standards; (g) agreeing to an arbitration clause to determine whether a given item of content satisfies a set of standards; (h) agreeing to an arbitration clause to determine the extent of damage that was inflicted by content that did not conform to a standard.
      1.3.3.2. LOGGING PROCESS TO TRACK CONTENT ORIGINS. Various parties may be interested in tracking the origins of content. For example, if an item of content is shown on a digital signage system, the system's owner may be interested in finding the originator of the content in the event that the item of content turns out not to comply with certain standards (e.g., the content turns out to be offensive). Other parties may be interested in tracking origins of content as well. For example, in order to ensure the integrity of an exchange, an owner or operator of the exchange may wish to verify that content ostensibly from a given source is in fact from that source and not from someone else pretending to be that source (e.g., from someone else trying to damage the ostensible source). In some embodiments, a party may have contact information on file, including email, phone, Web site, postal address, fax, etc. When a party submits content, a confirmation may be sent to the party's address. In some embodiments, the party must then respond and confirm that the content did originate with it. In some embodiments, the party may have the opportunity to respond (e.g., in the event that the party did not originate the content). In some embodiments, a party submitting content may apply a digital signature, digital watermark, or other confirmation that the content originated with it. For example, the party submitting content may: (1) take a sequence of bits representative of the content (e.g., a hash of all the bits in the content); (2) encrypt the sequence with the private key of the party, wherein the encryption protocol used is a public-key encryption protocol; (3) and transmit the encrypted version of the sequence to an exchange, signage network owner, or other receiving party. The fact that the submitting party's public key can be used, through the process of decryption, to arrive at the sequence may serve as verification of the identity of the party who submitted the content.
      1.3.3.3. INSURANCE, BONDING. In some embodiments, a provider of content (e.g., advertising content), or any other party, may purchase or otherwise obtain insurance. The insurance may insure the content provider against liability in the event that the content is found to violate a set of standards. In some embodiments, other parties may purchase insurance. For example, an exchange owner may purchase insurance that insures the exchange against liability in the event that content bought or sold on the exchange violates one or more sets of standards.
1.4. RATING AGENCIES. In some embodiments, an entity (e.g., a corporation; e.g., a government organization) may provide a rating to a digital signage system. A rating may summarize a state of a digital signage system. The rating may incorporate such factors as the reliability of the system, the downtime of the system, the average downtime of displays on the system, the quality of the displays, the resolution of the displays, the age of the displays, the impact of content shown on the displays (e.g., the percent of customers who recall information presented on the displays), the number of viewers of one or more displays in the network, the environment of the displays (e.g., the ambient noise level, e.g., the presence of potential distractions), the number of competing displays (e.g., the number or presence of other displays that could compete for viewers' attention), the quality of content on the displays (e.g., the quality of entertaining or informative content that accompanies advertisements), and any other factors. For example, each of one or more factors may be given a numerical score using tangible data (e.g., using data about system downtime), or using one or more expert evaluators. The scores may be weighted and then added, or otherwise combined. A rating may then be generated. The rating may be a numerical rating (e.g., a number between 0 and 100), a rating with stars (e.g., from 1 to 5 stars), a rating with letters (e.g., from “AAA” to “F”), or any other rating. In various embodiments, a digital signage system may receive two or more separate ratings, each rating corresponding to a different aspect or set of aspects about the system. For example, a given system may receive a rating of “A” for impact, but “C” for reliability. In various embodiments, one or more entities may become rating agencies, trusted rating agencies, or entities that are otherwise highly regarded (or regarded) for providing fair or useful ratings. In various embodiments, when content space is bought or sold, the rating of the content space (e.g., the rating of the digital signage system on which the space is being sold) may be specifically indicated. For example, a seller may sell 1000 hours of content space on a “B” rated digital signage system. Content space on a “B” system may generally sell for less than does content space on an “A” system.

When a buyer of content space has bought space of a particular rating, the buyer may thereby obtain the right to show content on a system of the given rating. In some embodiments, the buyer may obtain the right to show content on a system of the given rating or higher.
1.5. SUCCESS RATE. In some embodiments, a buyer and seller of content space may indicate a success rate. The success rate may measure the percentage of time that content scheduled to play on a digital signage system actually does play on the digital signage system. For instance, though content may be scheduled to play, a network outage, a display malfunction, or some other event may prevent content from actually playing. Example success rates may include 90%, 95%, 99%, or other possible success rates. For example, in some embodiments, if a buyer purchases 1000 hours of content space with a 95% success rate, then the buyer may expect its content to play for at least 950 hours on the digital signage system. In some embodiments, the buyer may receive a report indicating the actual play time of its content.

### Capture Someone's Face and do Transition Effects on it

In some embodiments, a camera associated with system 100 may capture an image or video of a person. A display may then show the image or video of the person. In some embodiments, transition effects may be added to the image or video. For example, the person may be shown fading in or fading out. The image of the person may be made to appear filled with ripples, like the surface of a pond. In some embodiments, alterations to a viewer's face may be added. For example, a mustache or beard may be added. Fangs may be added, e.g., in keeping with a Halloween theme. The effects that are added to a person's image may provide entertainment to the person and his/her friends.

The following are embodiments, not claims:

A. A contract for the use of display screens comprising:
a specification of a screen size;
a specification of standards that make content permissible;
a specification of a deadline by which an item of content must be supplied;
a specification of a destination to which the item of content must be supplied; and
a specification of a first time period within which the item of content is to be played.
   B. The contract of embodiment A further comprising a specification of an amount of time.
   C. The contract of embodiment B in which the amount of time is an amount of time per screen.
   D. The contract of embodiment B in which the amount of time is a total amount of time.
   E. The contract of embodiment A further comprising a specification of a number of screens.
   F. The contract of embodiment A further comprising a specification of a number of impressions.
   G. The contract of embodiment A further comprising a specification of a number of impressions from people of a predetermined demographic.
   H. The contract of embodiment A further comprising a specification of a number of times the item of content will be played.
   I. The contract of embodiment A in which a specification of screen size includes a specification of a measure, in inches, of the diagonal of the screen.
   J. The contract of embodiment A in which standards that make content permissible include standards that forbid political opinions.
   K. The contract of embodiment A further comprising a specification of a penalty for supplying content that does not comply with the standards.
   L. The contract of embodiment A further comprising a specification of a geographic region in which the content will play.
   M. The contract of embodiment A further comprising a specification of an area per screen that the item of content will occupy.
   N. The contract of embodiment M in which the screen area is one quarter of a screen.
   O. The contract of embodiment A further comprising a specification of a percentage of time that the item of content must play successfully.
   P. The contract of embodiment A further comprising a specification of a mechanism by which the playing of the item of content will be proven.
   Q. The contract of embodiment A further comprising a specification of a quality rating for a system of displays on which the item of content will be played.
   R. The contract of embodiment A, in which the contract comprises a security.
   S. The contract of embodiment A further comprising a specification of a category of product that the item of content must feature.
   T. A method for scheduling comprising:
determining a first category for a first item of content;
determining a second category for a second item of content;
scheduling the first item of content to play in a first region of a display at a first time;
determining whether the second category is the same as the first category; and
scheduling the second item of content to play in a second region of the display at the first time only if the second category is not the same as the first category.

The following are embodiments, not claims:

A. A method comprising:
determining data associated with a first item of content;
determining a first time when the first item of content is scheduled to play in a first region of a display;
determining a criterion associated with a second item of content;
determining, based on the data, that the first item of content satisfies the criterion;
determining a second time based on the first time; and
scheduling the second item of content to play in a second region of the display at the second time.
   B. The method of embodiment A in which the first item of content is a video featuring a news segment, and the second item of content is a video featuring an advertisement.
   C. The method of embodiment A in which the data associated with the first item of content is a set of keywords that are descriptive of the first item of content.
   D. The method of embodiment C in which the criterion specifies a word and in which determining that the first item of content satisfies the criterion includes determining that the set of keywords includes the word.
   E. The method of embodiment A in which determining a first time includes determining a time in the future.
   F. The method of embodiment A in which determining a second time includes determining a second time that is the same as the first time.
   G. The method of embodiment A in which determining a second time includes determining a second time that is before the first time.
   H. The method of embodiment A in which determining a second time includes determining a second time that is after the first time.
   hh. The method of embodiment A in which data associated with the first item of content includes a closed captioning feed, in which the criterion associated with the second item of content specifies a keyword, and in which determining that the first item of content satisfies the criterion includes determining that the keyword is contained within the closed captioning feed.
   hhh. The method of embodiment hh in which determining that the keyword is contained within the closed captioning feed includes performing a text search of the closed captioning feed.
   I. A method comprising:
playing a first item of content in a first region of a display;
playing, simultaneously to the first item of content, a second item of content in a second region of the display;
determining that a viewer is gazing towards the first region; and
enhancing the perceptibility of the first item of content.
   J. The method of embodiment I in which determining that a viewer is gazing towards the first region includes:
capturing an image of the viewer's face;
determining, based on the image, the distance of the viewer from the display;
determining, based on the image, the angle of the viewer with respect to the plane of the display; and
determining, based on the image, the direction in which the viewer's pupils are focused.
   K. The method of embodiment I in which enhancing the perceptibility of the first item of content includes:
enlarging the first region based on the determination that the viewer is gazing towards the first region; and
scaling the first item of content to fit within the newly enlarged first region.
   L. The method of embodiment K further including:
shrinking the second region; and
scaling the second item of content to fit within the newly shrunk second region.
   M. The method of embodiment I in which enhancing the perceptibility of the first item of content includes eliminating the second region.
   N. The method of embodiment I in which enhancing the perceptibility of the first item of content includes increasing the volume of audio associated with the first item of content.
   O. The method of embodiment I in which enhancing the perceptibility of the first item of content includes directing a beam of directional sound towards the viewer.
   P. The method of embodiment I in which enhancing the perceptibility of the first item of content includes changing the play rate of the first item of content.
   Q. A method comprising:
receiving an indication of a first set of content with a first total playing time;
receiving an indication of a first region of a display in which the first set of content is scheduled to play;
receiving an indication of a second set of content with a second total playing time;
receiving an indication of a second region of the display in which the second set of content is scheduled to play;
determining that the second total playing time is less than the first total playing time; and
providing an indication that the second total playing time is less than the first total playing time.
   R. The method of embodiment Q in which providing an indication includes altering the color of a representation of the second region as an indication that the second total playing time is less than the first total playing time.
   S. The method of embodiment Q further comprising:
determining a portion of the second set of content; and
scheduling the portion of the second set of content to play in the second region after the second set of content has played.
   T. The method of embodiment Q further comprising:
determining a third set of content; and
scheduling the third set of content to play in the second region after the second set of content has played.
   U. The method of embodiment Q further comprising increasing the total playing time of the second set of content.

### Chalkboard Screen

In various embodiments, a screen may simulate a chalkboard or other medium for writing. For example, a screen may serve as a digital menu board. A restaurant employee or manager may write menu items, prices, specials, etc., on the digital menu board as if he were writing on a chalk board. The screen may be touch sensitive or may be sensitive to a writing implement, such as an electronic piece of chalk, an electronic pen, an electronic pencil, or other electronic writing utensil, or any other writing implement. As will be appreciated, the writing implement or utensil need not be electronic, but may be made of any material. The material may be a material that is recognizable so as to create an input that can be translated, e.g., into a written word, a graphic or other item, such as an item to be displayed on the screen. A writing implement may include a pointed piece of plastic, a wand, or a finger, in various embodiments.

A screen may employ various technologies to register touch or contact, as will be appreciated. Exemplary technologies include resistive, surface acoustic wave, capacitive, surface capacitive, projected capacitive, infrared, strain gauge, optical image, dispersive signal technology, and acoustic pulse recognition. Following a touch or contact, a controller may register the touch and provide information about the touch to the processor or other circuit controlling the display. This process may occur via a software driver (e.g., the Windows 7 Touch Screen Driver; e.g., Evtouch).

In various embodiments, inputs from the user's writing implement may be detected (e.g., via a touch sensitive screen overlay), translated into electronic encoding, and stored. The inputs may be stored, for example, as a X-Y coordinates, as a number representing an applied pressure, as a three numbers representing a color (e.g., numbers representing each of red, green, and blue), as numbers representing a hue, saturation, contrast, blurring, or as any other representation of the user's input. In various embodiments, a representation of the user's input may be stored as a file, such as a bitmap file, a jpeg file, a gif file, or any other file.

Once a restaurant employee or other person has written or marked on a digital screen, the writing may be displayed on the screen. The writing may reflect the person's method of input, including the trajectory of the writing implement, the pressure applied, the speed of the writing, or any other manner of input. For example, the writing may be thicker if more pressure has been applied, and thinner if less pressure has been applied. A person may have the opportunity to customize, stylize or alter the writing in various ways. For example, the person may select a color and apply the color to his writing or markings. For example, if the person picks the color green (e.g., from a color picker or color palette), then the person's writings may be made to appear as if from green chalk.

A representation of the user's input may be displayed on a screen. In some embodiments, a user may make his inputs (e.g., may write) on a given screen, and a representation of the user's inputs may be displayed on that same screen. In some embodiments, a user may make inputs on a first screen, and a representation of those inputs (e.g., an electronic encoding of those inputs) may be transmitted to a second screen for display. Thus, for example, a user may make markings on a single screen and have such markings transmitted to each of three additional screens (e.g., of a 3-panel menu board; e.g., of a 4-panel menu board).

For example, a user may interact with a first screen that represents a workstation (e.g., a workstation for restaurant employees). The person may make writings on the screen using an electronic pen. The person may then select a second screen that is hanging from the ceiling (e.g., a screen being used as a menu board). Once the user has selected the second screen, the writings made by the user on the first screen may be transmitted to the second screen. The writings may then be displayed on the second screen. The transmission may occur via a network, such as a local area network, wide area network, the Internet, wireless network, or via any other network, or via any other mode of transmission.

Thus, in various embodiments, the first screen may act as a dashboard, command center, and/or user interface that is visible only to store managers or employees, while the second screen may represent a menu, sign, or other type of display that is intended for patrons, guests, and/or customers.

In some embodiments, after the writings have been transmitted to the second screen, the user may clear the first screen of writings (e.g., by pressing or selecting a button on the first screen, by pressing an appropriate key combination on a keyboard, or through any other means). The user may then create new writings on the first screen, and then have the new writings transmitted to a third screen. The third screen may represent part of the same menu board as the second screen. For example, the second screen and the third screen may comprise two panels of the same menu board. As will be appreciated, the first screen may be used to create writings, markings, images, etc., for any number of additional screens.

Articulated Arm with Screen

In various embodiments, a given screen may function both as a workstation and/or input terminal, and as a display meant for customers, patrons, and so on. In some embodiments, a user (e.g., a restaurant employee) may make markings on a screen. The screen may display a representation of such markings. The screen may then be positioned to be more visible to patrons and customers. For instance, the user may position the screen at his own chest level in order to make markings on the screen. But once a representation of such markings has been displayed on the screen, the screen may be raised to a level above the user's head so as to be more visible to customers.

In various embodiments, a screen may be mounted or attached to an arm (e.g., to a metal arm). For example, one end of the arm may be affixed to the back of the screen using bolts, screws, etc. The arm may include one or more joints at which the arm can bend to various degrees. The arm may also be affixed to a ceiling, wall stand, or other structure. Thus, for example, the arm may be attached at one end to the screen and at its other end to a wall. The joint or joints of the arm may include considerable mechanical resistance, which may be achieved in a variety of ways, as will be appreciated (e.g., via friction pads). Thus, in various embodiments, the joint or joints of the arm may maintain their angle(s) even while bearing the weight of the screen. Additionally, the joint or joints may include pins to fix the angle, or other means to fix the angle, as will be appreciated.

In various embodiments, an operator or user of the screen may alternately pull the screen (thereby extending the arm, for example), or push the screen (thereby retracting the arm, for example). The joints may allow bending, for example, only with the added force provided by a human. When the user pushes the screen, the user may push the screen towards a wall, ceiling, or other anchor point for the screen. At this point, the screen may be in a position designed for high or optimal visibility. When the user pulls the screen, the user may bring the screen down, or otherwise towards the user to enable the user to interact with the screen. The user may then create text, graphics, effects or other items for display on the screen. For example, the user may use a stylus to “write” on the screen as if he were using a chalk board. Once the user has finished interacting with the screen, the user may push the screen back to its position of heightened visibility.

In various embodiments, a screen may be attached to a ceiling via an articulating arm. In various embodiments, a screen may be attached high on a wall via an articulating arm. The screen may serve as a digital menu board. When the screen is pushed close to the ceiling or wall (e.g., when the arm is in a folded state), the screen may serve as a digital menu visible to customers. On the other hand, when the arm is extended, a restaurant manager or employee may have the opportunity to touch and interact with the screen and to thereby make changes to the screen.

In various embodiments, a screen may be attached to a wall or other structure using a telescoping arm or using any other extendable or retractable arm. In various embodiments, a screen may be attached to a wall or other structure using more than one arm.

In various embodiments, a screen may be locked in place. For example, when a screen is pushed close to a wall, ceiling, or other structure (e.g., when the arm supporting the screen is in a folded or retracted state), the screen may be locked in place. The screen may be locked, for example, using a pin. The pin may fit into a hole on a fixture attached to the screen, and it may also fit into a hole on a fixture attached to the wall or other structure. If the pin is rigid, for example, the pin may thereby lock the screen to the wall or other fixture, as will be appreciated. Locking the screen in place may reduce the possibility that the arm holding the screen will extend on its own under the screen's weight. As will be appreciated, various other means may be used to lock the screen in place. For example, a hook attached to the screen may fit into a metallic loop attached to the wall. Or, a hook attached to the wall may fit into a metallic loop attached to the screen. Multiple hooks, pins, or other locking or fixing means may be used, as will be appreciated.

In various embodiments, a screen may be supported by an arm or other support structure that is jointed or otherwise capable of allowing the screen to tilt, or rotate about one or more axis. For example, the screen may be tilted up or down or side to side. As another example, the screen may be rotated as to its orientation, and may, for instance, be switched from portrait to landscape view, or vice versa. A support structure allowing a screen to title is described in U.S. Pat. No. 5,938,163, entitled “Articulating Touchscreen Interface”, the entirety of which is incorporated by reference herein for all purposes.

In various embodiments, a screen may include a processor, such as a processor in the Intel Pentium series, an Athlon processor, an Arm processor, or any other processor. The screen may further include a graphics processing unit (GPU). The screen may further include a memory, which may include flash memory, disk-based memory, magnetic memory, optical memory, holographic memory, or any other form of memory.

The screen may store (e.g., in memory), various templates, effects, graphics, and/or algorithms for creating the appearance of chalk markings. For example, the screen may store an algorithm for translating a stroke detected on the contact-sensitive portion (e.g., the touch portion), into a stroke that appears to have been made by a piece of chalk on a blackboard. In various embodiments, the appearance of a chalk marking may be created by (1) detecting the trajectory of a stroke or marking made on a contact sensitive portion of a screen; (2) adding or defining a predetermined thickness to the trajectory (e.g., 3 millimeters); (3) applying a filter to create noise (e.g., an “add noise” filter in Adobe Photoshop); and (4) applying a filter to add blur (e.g., applying a Gaussian blur with radius of, for instance, 0.4 in Adobe Photoshop). In some embodiments, an “add noise” filter, or other filter, may create extraneous points, pixels, markings, or the like that are within a predetermined distance of the originally detected stroke. The points may be added according to some probability distribution, such as according to a bell curve (Gaussian), or according to a uniform probability distribution, or according to any other distribution, as will be appreciated. In some embodiments, applying a blurring filter may take existing points, pixels, and/or, markings, or collections of points, pixels, and/or markings, and may spread or smear these out using some mathematical function. For example, a single pixel may be smeared by applying a Gaussian function, such that the color, brightness, and/or other attributes of the pixel are copied to some degree to surrounding pixels, but to a lesser and lesser degree as the distance from the original pixel increases. In some embodiments, an image or other stored marking may be blurred via convolution with a mathematical function, such as with a Gaussian function. An image may be blurred via filtering in the frequency domain as well, as will be appreciated. As will be appreciated, according to various embodiments, other methods may be used for generating the appearance of chalk markings.

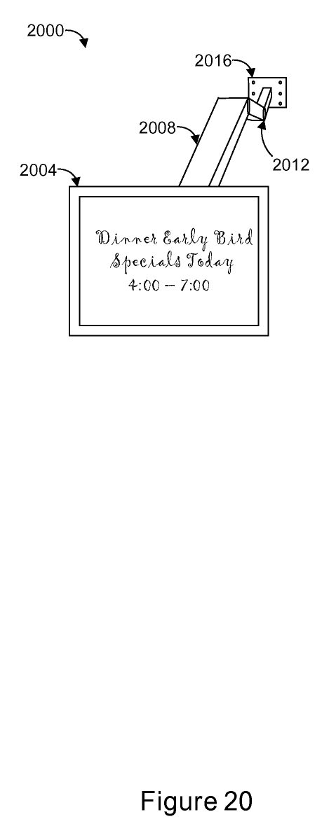

FIG. 20 shows an illustrative display 2000 according to various embodiments. A display screen 2004 is supported by an arm 2008. The arm may be attached to the back of the display screen via screws, bolts, welds, glue, or via any other means. The arm may include one or more joints (e.g., joint 2012), and/or one or more bendable or flexible portions. The arm may, in turn, be attached or affixed to a wall, ceiling or other structure. For example, attachment plate 2016 may be affixed to a wall via one or more screws, and may in turn support the arm. FIG. 20 illustrates arm 2008 in a somewhat extended state. However, it will be appreciated that the arm could be in a more folded state, in which case display screen 2004 would be closer to attachment plate 2016. FIG. 20 illustrates exemplary writings on display screen 2004, according to some embodiments, where such writings may be designed to mimic the appearance of chalk markings.

The following are embodiments, not claims:

A. An apparatus comprising:
an electronic display with a contact-sensitive portion;
an arm attached to the display, in which the arm can take at least two configurations; and
a processor, the processor operable to:
   receive an indication of a first contact with the contact-sensitive portion;
   determine a first visual representation based on the first contact, in which the first visual representation simulates the marking of chalk on a chalkboard; and
   cause the electronic display to output the first visual representation.

The configurations of the arm, for example, may include a first configuration where the arm is bent at a joint, and a second configuration where the arm is not bent at the joint. In some embodiments, the configurations of the arm may include a first configuration where the arm is telescoped fully, and a second configuration where the arm is not telescoped fully. In some embodiments, the configurations of the arm may include a first configuration where a joint of the arm tilts the screen in a first direction, and a second configuration where the joint of the arm tilts the screen in a second direction. Also, it will be appreciated that the processor may include a generic processor, a graphic processing unit, an electronic circuit, a logic device, a combination of a generic processor and a graphics processing unit, or any combination of the aforementioned.

B. The apparatus of embodiment A in which the electronic display is a liquid crystal display screen, in which the contact-sensitive portion includes an overlay using capacitive technology, and in which the arm is bendable about a joint.
C. The apparatus of embodiment A in which, in order to determine the first visual representation, the processor is operable to:
determine a first trajectory of the first contact based on the received indication of the first contact;
apply a noise filter to the first trajectory; and
apply a blurring filter to the first trajectory.
   D. The apparatus of embodiment C, in which the processor is further operable to:
receive an indication of a second contact with the contact-sensitive portion;
determine a color based on the second contact;
determine a second visual representation by applying the color to the first visual representation; and
cause the electronic display to output the second visual representation.

For example, a user may make a marking on the display, and may then select from a color menu or palette on the display in order to apply a different color the markings. The user may interact with the color menu or palette in the upper left corner of the display, or in some other portion of the display. In some embodiments, the user may activate the color palette or some other menu or selection area by interacting with the display in a particular way. For example, a menu may come up when the user taps the display twice or when the user makes a specialized marking, for example. Otherwise, in various embodiments, user contact with the display may be interpreted as images or graphics that are being created by the user.

E. The apparatus of embodiment C, in which the processor is further operable to:
receive an indication of a second contact with the contact-sensitive portion;
determine a selection of a first time in the future based on the second contact;
determine when the current time matches the first time; and
cause the electronic display to output the first visual representation only when the current time matches the first time.

In various embodiments, a user may interact with the display in order to schedule when content will actually be displayed. For example, the user may create a dinner menu, with the intention that the menu be displayed during dinner time. Accordingly, the user may schedule the menu to be displayed at 6:00 PM in the afternoon, but not before. Thus, for example, a user may write up the dinner specials on the display. The user may then interact with a scheduler or other selection area on the display in order to schedule a time when the dinner menu will be displayed.

Applicants claim:

1. A method comprising:
determining data associated with a first item of content;
determining a first time when the first item of content is scheduled to play in a first region of a display;
determining a criterion associated with a second item of content;
determining, based on the data, that the first item of content satisfies the criterion;
determining a second time based on the first time; and
scheduling the second item of content to play in a second region of the display at the second time.

2. The method of claim 1 in which the first item of content is a video featuring a news segment, and the second item of content is a video featuring an advertisement.

3. The method of claim 1 in which the data associated with the first item of content is a set of keywords that are descriptive of the first item of content.

4. The method of claim 3 in which the criterion specifies a word and in which determining that the first item of content satisfies the criterion includes determining that the set of keywords includes the word.

5. The method of claim 1 in which determining a second time includes determining a second time that is the same as the first time.

6. The method of claim 1 in which determining a second time includes determining a second time that is before the first time.

7. The method of claim 1 in which data associated with the first item of content includes a closed captioning feed, in which the criterion associated with the second item of content specifies a keyword, and in which determining that the first item of content satisfies the criterion includes determining that the keyword is contained within the closed captioning feed.

8. The method of claim 7 in which determining that the keyword is contained within the closed captioning feed includes performing a text search of the closed captioning feed.

9. A method comprising:
playing a first item of content in a first region of a display;
playing, simultaneously to the first item of content, a second item of content in a second region of the display;
determining that a viewer is gazing towards the first region; and
enhancing the perceptibility of the first item of content.

10. The method of claim 9 in which determining that a viewer is gazing towards the first region includes:
capturing an image of the viewer's face;
determining, based on the image, the distance of the viewer from the display;
determining, based on the image, the angle of the viewer with respect to the plane of the display; and
determining, based on the image, the direction in which the viewer's pupils are focused.

11. The method of claim 9 in which enhancing the perceptibility of the first item of content includes:
enlarging the first region based on the determination that the viewer is gazing towards the first region; and
scaling the first item of content to fit within the newly enlarged first region.

12. The method of claim 11 further including:
shrinking the second region; and
scaling the second item of content to fit within the newly shrunk second region.

13. The method of claim 9 in which enhancing the perceptibility of the first item of content includes increasing the volume of audio associated with the first item of content.

14. The method of claim 9 in which enhancing the perceptibility of the first item of content includes directing a beam of directional sound towards the viewer.

15. The method of claim 9 in which enhancing the perceptibility of the first item of content includes changing the play rate of the first item of content.

16. An apparatus comprising:
an electronic display with a contact-sensitive portion;
an arm attached to the display, in which the arm can take at least two configurations; and
a processor, the processor operable to:
receive an indication of a first contact with the contact-sensitive portion;
determine a first visual representation based on the first contact, in which the first visual representation simulates the marking of chalk on a chalkboard; and
cause the electronic display to output the first visual representation.

17. The apparatus of claim 16 in which the electronic display is a liquid crystal display screen, in which the contact-sensitive portion includes an overlay using capacitive technology, and in which the arm is bendable about a joint.

18. The apparatus of claim 16 in which, in order to determine the first visual representation, the processor is operable to:
determine a first trajectory of the first contact based on the received indication of the first contact;
apply a noise filter to the first trajectory; and
apply a blurring filter to the first trajectory.

19. The apparatus of claim 18, in which the processor is further operable to:
receive an indication of a second contact with the contact-sensitive portion;
determine a color based on the second contact;
determine a second visual representation by applying the color to the first visual representation; and
cause the electronic display to output the second visual representation.

20. The apparatus of claim 18, in which the processor is further operable to:
receive an indication of a second contact with the contact-sensitive portion;
determine a selection of a first time in the future based on the second contact;
determine when the current time matches the first time; and
cause the electronic display to output the first visual representation only when the current time matches the first time.
